(19) United States
(12) Patent Application Publication
(10) Pub. No.: US 2026/0349522 A1
(43) Pub. Date: Nov. 5, 2026

(54) SYSTEM AND METHOD FOR GESTURE-BASED INITIATION OF A COMPUTING OPERATION

(71) Applicant: The Toronto-Dominion Bank, Toronto (CA)

(72) Inventors: Dmytro BABENKO, Mississauga (CA); Disha VADODARIA, Bensalem, PA (US); Chirayu PATEL, Mississauga (CA); Sakikun ISLAM-NAHAR, Bethpage, NY (US); Heather BAIRD, Austin, TX (US); Roman MELNYK, Windham, ME (US); Joseph SANSOTTA, Langhorne, PA (US)

(73) Assignee: The Toronto-Dominion Bank, Toronto (CA)

(21) Appl. No.: 19/194,711

(22) Filed: Apr. 30, 2025

(51) Int. Cl. G06F 3/01; G06F 3/0482; H04L 67/52

(52) U.S. Cl. CPC G06F 3/017; G06F 3/0482; H04L 67/52

(57) ABSTRACT

A method and system for gesture-based initiation of an operation over a network. A computer system may receive a search request from a first device. The computer system may also detect, based on sensor data, that a second device has been subject to a second gesture. The computer system may obtain location indicators corresponding to the first device and the second device. The computer system may further determine, based on the location indicators, that the first device and the second device are in a shared area. In response thereto, the computer system may initiate a computing operation involving the first device and the second device. The computer system may use machine learning to 1) identify the second gesture based on the sensor data or 2) identify the second device as a target of the first device or vice versa.

### TECHNICAL FIELD

The present application relates to systems and methods for sensor data and location data based operations.

### BACKGROUND

Computing operations over a network such as the Internet involving the identification of a target or grouping of devices or accounts are commonplace. Examples of such operations include, without limitation, connecting accounts over social media (e.g. a follow request on social media), mobile data sharing, and data transfers. In some instances, individuals in the same area or proximate locations (e.g. standing beside each other) may engage in such a computing operation. In these instances, the user interface (UI) for initiating such a computing operation may be cumbersome or time consuming. Moreover, the proximate locations of the individuals and sensor data relating to devices held by the individuals may be used to simplify the operation for the individuals. For example, navigating a UI to identify a target account on social media, identify a target device to share mobile data with, or identify a target destination for a data transfer may be simplified by taking advantage of the proximate locations and the sensor data.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a simplified schematic diagram showing components of an example computing device;

FIG. 3 is a high-level schematic diagram of an example computer system;

FIG. 4 shows a simplified organization of software components stored in a memory of the computer system of FIG. 3;

FIG. 5 shows, in flowchart form, an example method for identifying a target based on location;

FIG. 6 is a simplified diagram illustrating a machine learning model to determine that a device has been subject to a gesture;

FIG. 7 shows, in flowchart form, an example method for initiating a computing operation in response to identifying a target based on sensor data and location;

FIG. 8 shows, in flowchart form, an example method for identifying, among a plurality of potential targets, an expected target relative to the other potential targets;

FIG. 9 is a simplified diagram illustrating using a machine learning model to identify an expected target;

FIG. 10 shows, in flowchart form, an example method for using an application and sensor data to identify a target based on location data;

FIG. 11 shows, in flowchart form, an example method for activating a sensor of a computing device;

FIGS. 12A-12C show an example computing device displaying a UI for computing operations initiated by detection of a gesture;

FIG. 13 shows another example computing device displaying a UI for computing operations initiated by detection of a gesture;

FIG. 14 shows another example computing device displaying a UI for computing operations initiated by a detection of a gesture;

FIG. 15 is another schematic operation diagram illustrating an operating environment of another example embodiment; and

FIG. 16 shows, in flowchart form, another example method for initiating a computing operation based on sensor data and location data.

Like reference numerals are used in the drawings to denote like elements and features.

### DETAILED DESCRIPTION OF VARIOUS EMBODIMENTS

In an aspect, the present application discloses a computer system. The computer system comprises a processor, a communications module coupled to the processor, and a memory coupled to the processor. The memory stores instructions that, when executed by the processor, configure the processor to: receive, from a first device and via the communications module, a search request; obtain a first location indicator associated with the first device; receive, from a second device and via the communications module, gesture data, the gesture data indicating that the second device has been subject to a gesture; obtain a second location indicator associated with the second device; determine, based on the first location indicator and the second location indicator, that the first device and the second device are in a shared area; and initiate, in response to determining that the first device and the second device are in the shared area, a computing operation involving the first device and the second device.

In some implementations, receiving the search request further comprises receiving, from the first device and via the communications module, first gesture data, the first gesture data indicating that the first device has been subject to a first gesture.

In some implementations, the instructions further configure the processor to, in response to receiving the gesture data, determine that the second device has been subject to the gesture by: providing, to a machine learning model, the gesture data; and receiving, from the machine learning model, a gesture indicator, the gesture indicator indicating that the second device has been subject to the gesture.

In some implementations, the instructions further configure the processor to, prior to initiating the computing operation: determine a first time associated with the receiving of the search request; determine a second time associated with the gesture; and determine that the first time and the second time are within a time threshold.

In some implementations, initiating the computing operation further comprises: sending, in response to determining that the first device and the second device are in the shared area, and via the communications module, a selection signal to the first device, the selection signal causing the first device to display a selectable user interface element associated with the second device; and receiving, from the first device and via the communications module, a target selection signal indicating selection of the selectable user interface element by the first device.

In some implementations, the instructions further configure the processor to, prior to sending the selection signal: receive, from a third device and via the communications module, third gesture data, the third gesture data indicating that the third device has been subject to a third gesture; determine that the second device is an expected target relative to the third device; and configure, based on the second device being the expected target relative to the third device, the selection signal to cause the first device to display a user interface. The user interface: includes the selectable user interface element; and indicates, in response to determining that the second device is the expected target relative to the third device, that the second device is the expected target relative to the third device.

In some implementations, the instructions further configure the processor to: obtain, prior to determining that the second device is the expected target relative to the third device, a third location indicator associated with the third device; and determine that the second device is the expected target relative to the third device by determining, based on the first location indicator, the second location indicator, and the third location indicator, that the first device is spatially closer to the second device than to the third device.

In some implementations, the instructions further configure the processor to determine that the second device is the expected target by: providing, to a machine learning model, first data associated with the first device, second data associated with the second device, and third data associated with the third device; and receiving, from the machine learning model, a preference indicator, the preference indicator indicating that the second device is the expected target relative to the third device.

In some implementations, the first data includes a computing operation history associated with the first device.

In some implementations, the instructions further configure the processor to, prior to sending the selection signal: determine a first time associated with the receiving of the search request; determine a second time associated with the gesture; determine a third time associated with the third gesture; and determine, based on the first time, the second time, and the third time, that the second device is the expected target relative to the third device.

In some implementations, the instructions further configure the processor to, prior to configuring the selection signal: obtain, a third location indicator associated with the third device; and determine, based on the first location indicator and the third location indicator that the first device and the second device are in the shared area. The instructions may further configure the processor to, prior to sending the selection signal configure the user interface to include, in response to determining that the first device and the third device are in the shared area, an additional selectable user interface element associated with the third device; and configure the user interface to indicate that the second device is the expected target relative to the third device by biassing selection of the selectable user interface element over the additional selectable user interface element.

In some implementations, the user interface biases selection of the selectable user interface element over the additional selectable user interface element by enlarging the selectable user interface element relative to the additional selectable user interface element.

In some implementations, the instructions further configure the processor to, prior to receiving the gesture data: receive, from the first device and via the communications module, an application state indicator, the application state indicator indicating a state of an application launched by the second device; determine, based on the application state indicator, that the application is in a search state; and send, in response to determining that the application is in the search state, to the second device and via the communications module, a monitoring signal. The monitoring signal causes: a sensor of the second device to monitor motion of the second device; and the second device to send the gesture data to the computer system.

In some implementations, the instructions further configure the processor to, prior to sending the monitoring signal: receive authentication credentials from the second device; and verify that the authentication credentials correspond to an account associated with the second device.

In some implementations, the instructions further configure the processor to send a selection signal to the second device. The selection signal causing the second device to: determine that the application is a foreground process; and interrupt, in response to determining that the application is the foreground process, device operation to display a user interface including a selectable user interface element associated with the first device.

In another aspect, the present application discloses a computer-implemented method. The method comprises: receiving, from a first device and via a communications module, a search request; obtaining a first location indicator associated with the first device; receiving, from a second device and via the communications module, gesture data, the gesture data indicating that the second device has been subject to a gesture; obtaining a second location indicator associated with the second device; determining, based on the first location indicator and the second location indicator, that the first device and the second device are in a shared area; and initiating, in response to determining that the first device and the second device are in the shared area, a computing operation involving the first device and the second device.

In some implementations, initiating the computing operation further comprises: sending, in response to determining that the first device and the second device are in the shared area, and via the communications module, a selection signal to the first device, the selection signal causing the first device to display a selectable user interface element associated with the second device; and receiving, from the first device and via the communications module, a target selection signal indicating selection of the selectable user interface element by the first device.

In some implementations, the method further comprises, prior to sending the selection signal receiving, from a third device and via the communications module, third gesture data, the third gesture data indicating that the third device has been subject to a third gesture; determining that the second device is an expected target relative to the third device; and configuring, based on the second device being the expected target relative to the third device, the selection signal to cause the first device to display a user interface. The user interface: includes the selectable user interface element; and indicates that the second device is the expected target relative to the third device.

In some implementations, the method further comprises, prior to receiving the gesture data: receiving, from the second device and via the communications module, an application state indicator, the application state indicator indicating a state of an application launched by the second device; determining, based on the application state indicator, that the application is in a search state; and sending, in response to determining that the application is in the search state, to the second device and via the communications module, a monitoring signal. The monitoring signal causes: a sensor of the second device to monitor motion of the second device; and the second device to send the gesture data to a computer system.

In another aspect, the present application discloses a non-transitory computer-readable medium. The computer-readable medium stores processor-executable instructions that, when executed by a processor, cause the processor to: receive, from a first device and via a communications module, a search request; obtain a first location indicator associated with the first device; receive, from a second device and via the communications module, gesture data, the gesture data indicating that the second device has been subject to a gesture; obtain a second location indicator associated with the second device; determine, based on the first location indicator and the second location indicator, that the first device and the second device are in a shared area; and initiate, in response to determining that the first device and the second device are in the shared area, a computing operation involving the first device and the second device.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

Computing operations over a network such as connecting social media accounts, executing mobile data sharing, or performing a data transfer often involve navigating a UI to identify a target. For example, sending a connection request (e.g. a follow request on social media) may involve using a UI to manually search for a target account to send the connection request. In another example, performing a data transfer from a source device (first device) to a target device (second device) may involve manually navigating a UI on the source device to identify an identifier associated with the target device. Such approaches may be cumbersome. Specifically, a process such as searching for a target via a UI (for example using a search bar) takes manual effort and time. At least some of the embodiments described herein address reducing such manual effort and time in instances wherein the source device and target device are proximate. Specifically, sensor data from sensors and location data and/or indicators associated with the source device and target device may be used to initiate the computing operation and reduce the discussed manual effort and time.

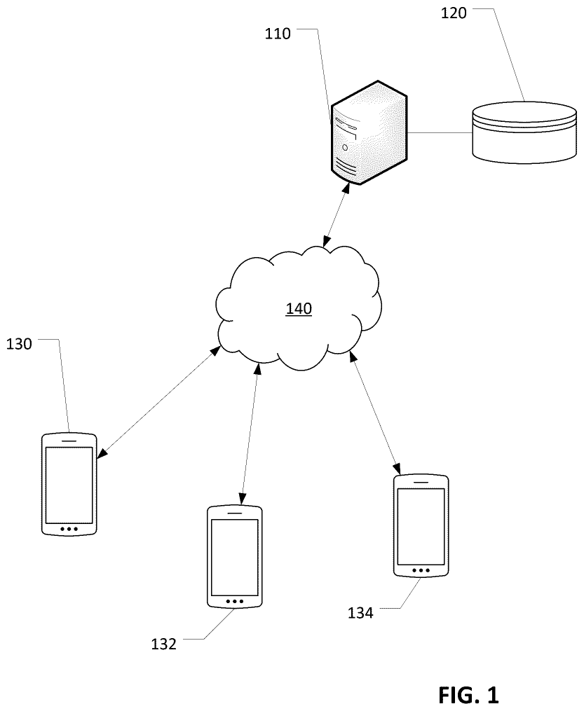

FIG. 1 is a schematic operation diagram illustrating an operating environment of an example embodiment. As shown, the operating environment includes a computer system 110 (illustrated as a server), a database 120 coupled to the computer system 110, a first computing device 130, a second computing device 132, a third computing device 134, and a network 140 connecting the computer system 110 to the computing devices 130, 132, and 134. The computer system 110 and the computing devices 130, 132, and 134 may be in geographically disparate locations. Put differently, the computer system 110, and the computing devices 130, 132, and 134 may be located remote from one another.

The computer system 110 may maintain a database 120 that includes various data records. For example, the computer system 110 may be a social media server which maintains social media accounts. In this example, a data record may, for example, include social media posts and connections between different social media accounts. In another example, the computer system 110 may be a financial institution server which maintains bank accounts. In this example, a data record may, for example, reflect an amount of value stored in a particular account associated with a user. The amount of value may include a quantity of currency.

The database 120 may include data records for a plurality of resource accounts and at least some of the data records may define a quantity of resources associated with an account holder. For example, an account holder associated with the first computing device 130 may be associated with one or more resource accounts having one or more data records in the database 120. The data records may reflect a quantity of resources that are available to the account holder. Such resources may include owned resources (e.g. digital tokens) and, in at least some embodiments, borrowed resources (e.g. resources available on credit). The quantity of resources that are available to or associated with an account holder may be reflected by a balance defined in an associated data record such as, for example, a digital token balance or bank balance. The resource accounts may include, for example, a token account, a digital wallet account, a mobile data account, a chequing account, a savings account, a borrowing account such as for example a line of credit account, a credit card account, a loyalty point account, etc. As such, at least some of the data records may define a chequing account balance, a savings account balance, a line of credit account balance, a credit card account balance, a loyalty point account balance, etc.

The database 120 may additionally include data records for storing identity data of account holders. The identity data may include, for example, a name, an email address, a social security number, an address, a phone number, etc. of the account holder. The identity may include identity data previously obtained to fulfill know-your-customer (KYC) requirements. The database 120 may store additional information such as authentication data such as usernames and corresponding passwords. Additionally or alternatively, the database 120 may store an indication that one or more computing devices have passkeys installed thereon. The database 120 may further store one or more passkeys that may be used to authenticate an account holder or computing device.

The computing devices 130, 132, and 134 may be computing devices that communicate with the computer system 110. The computing devices 130, 132, and 134 may interact with the computer system 110 to perform tasks such as, for example, performing computing operations over a network, managing account holder data and executing authentication procedures.

The computing devices 130, 132, and 134 may take a variety of forms including, for example, a mobile communication device such as a smartphone, a tablet computer, a wearable computer (such as a head-mounted display or smartwatch), a laptop or desktop computer, or a computing device of another type. The computing devices 130, 132, and 134 may store software instructions that cause the computing devices 130, 132, and 134 to establish communications with the computer system 110. In some instances, the computing devices 130, 132, and 134 may execute or perform these communications using an application maintained by the computer system 110.

In some embodiments, the first computing device 130 may act as a source device of a computing operation over a network, the second computing device 132 may act as a target device of the computing operation, and the third computing device 134 may act as a potential target device of the computing operation. For example, a social media account associated with first computing device 130 may initiate a social media connection with a social media account associated with the second computing device 132. In another example, the first computing device 130 may initiate a data transfer from a resource account associated with the first computing device 130 to a resource account associated with the second computing device 132.

The computing devices 130, 132, and 134 may be adapted to present a UI that allows for communication with the computer system 110 and/or each other. For example, the first computing device 130 may be adapted to receive, from the computer system 110, a signal that causes the first computing device 130 to display a UI associated with an application maintained by the computer system 110.

It should be appreciated that FIG. 1 illustrates a non-limiting example embodiment. While FIG. 1 illustrates the computer system 110 as a single server. In some embodiments, the computer system 110 may comprise a plurality of servers such as pooled cloud computing services. Likewise, while FIG. 1 illustrates three computing devices 130, 132, and 134, in other embodiments, the operating environment may include more or less such computing devices.

The network 140 may be a computer network. In some embodiments, the network 140 may be an internetwork such as may be formed of one or more interconnected computer networks. For example, the network 140 may be or may include an Ethernet network, an asynchronous transfer mode (ATM) network, a wireless network, a telecommunications network, or the like.

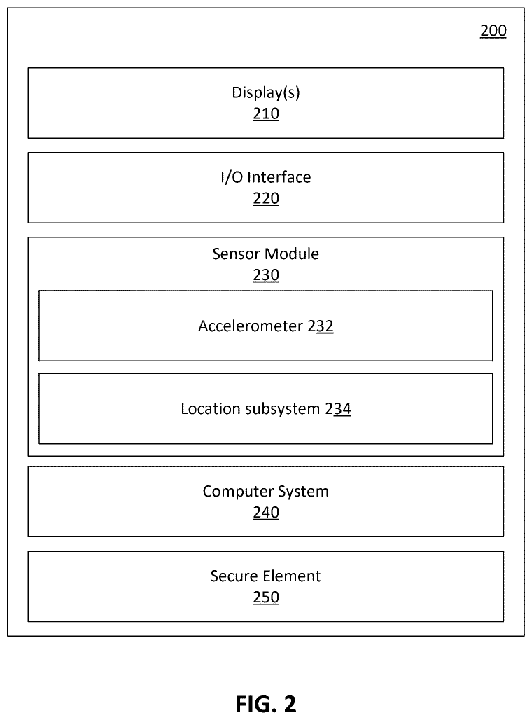

FIG. 2 is a simplified schematic diagram showing components of an exemplary computing device 200. The computing devices 130, 132, and 134 may be of the same type as the computing device 200 (see FIG. 1). The computing device 200 may also be exemplary of the computing devices 1530 and 1532 (see FIG. 15). The computing device 200 may include modules including, as illustrated, for example, one or more displays 210, an I/O interface 220, a sensor module 230, a computer system 240, and a secure element 250.

The one or more displays 210 are a display module. The one or more displays 210 are used to display screens of a UI that may be used, for example to communicate with the computer system 110 (see FIG. 1). The one or more displays 210 may be internal displays of the computing device 200 (e.g., disposed within a body of the computing device).

The I/O interface 220 may interface with input and output devices. Components of the computing device 200 that are input devices may include, without limitation, a button, a microphone, a touchscreen, and a keyboard. Components of the computing device 200 that are output devices may include, without limitation, a speaker, a vibration unit, and a display. In some examples, the same component may serve as both an input and output device (e.g., a display may be a touch-sensitive display).

The sensor module 230 may interact with systems and/or sensors that generate sensor data based on a sensed condition. Nonlimiting examples of such sensors include an accelerometer 232 and a location subsystem 234. The accelerometer 232 may detect or measure acceleration of the computing device 200. In some embodiments, the accelerometer 232 may be a microelectromechanical systems accelerometer. The location subsystem 234 may generate location data indicating a location of the computing device 200. The location may be a current geolocation of the computing device 200. The location subsystem 234 may be or include any one or more of a global positioning system (GPS), an inertial navigation system (INS), a wireless (e.g., cellular) triangulation system, a beacon-based location system (such as Bluetooth™ low energy beacon system), or a location subsystem of another type.

It should be appreciated that the sensor module 230 may include sensors and subsystems other than the accelerometer 232 or the location subsystem 234. By way of further example, the sensor module 230 may include a biometric subsystem which generates biometric data associated with a user of the computing device 200. The biometric subsystem may obtain biometric data that may be used to identify or verify the user based on one or more physical characteristics. The biometric subsystem may include one or more of a fingerprint scanner, a facial recognition camera, an iris scanner, or any other type of biometric sensor configured to capture and process unique biological identifiers of the user.

The computer system 240 is in communication with the one or more displays 210, the I/O interface 220, the sensor module 230, and/or the secure element 250. The computer system 240 may be or may include a processor which is coupled to the one or more displays 210, the I/O interface 220, and/or the sensor module 230.

The secure element 250 is a dedicated, tamper-resistant part of the computing device 200 that is configured to store sensitive data securely. The secure element 250 may be isolated from other systems of the computing device 200 making it resistant to hacking of unauthorized users. The secure element may be configured to manage cryptographic keys used for authentication and other sensitive processes.

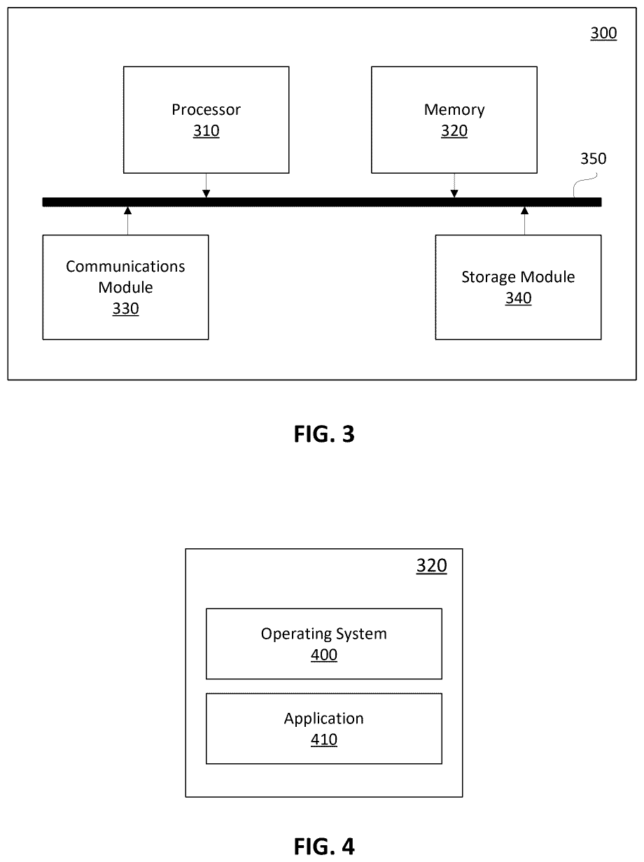

Referring now to FIG. 3, a high-level operation diagram of an example computer system 300 is shown. In some embodiments, the computer system 300 may be exemplary of the computer system 110 or the computer system 240 (see FIGS. 1 and 2).

The example computer system 300 includes a variety of modules. For example, as illustrated, the example computer system 300 may include a processor 310, a memory 320, a communications module 330, and/or a storage module 340. As illustrated, the foregoing example modules of the example computer system 300 are in communication over a bus 350.

The processor 310 is a hardware processor. The processor 310 may, for example, be one or more ARM, Intel x86, PowerPC processors or the like.

The memory 320 allows data to be stored and retrieved. The memory 320 may be a non-transitory computer-readable medium. The memory 320 may include, for example, random access memory (RAM), read-only memory (ROM), and persistent storage. Persistent storage may be, for example, flash memory, a solid-state drive or the like. ROM and persistent storage are non-transitory computer-readable storage mediums.

The communications module 330 allows the computer system 300 to communicate with other computer or computing devices and/or various communications networks. For example, the communications module 330 may allow the example computer system 300 to send or receive communications signals. Communications signals may be sent or received according to one or more protocols or according to one or more standards. For example, the communications module 330 may allow the example computer system 300 to communicate via a cellular data network, such as for example, according to one or more standards such as Global System for Mobile communications (GSM), Code Division Multiple Access (CDMA), Evolution Data Optimized (EVDO), Long-term Evolution (LTE), or the like. Additionally, or alternatively, the communications module 330 may allow the example computer system 300 to communicate using near-field communication (NFC), via Wi-Fi™, using Bluetooth™, or via some combination of one or more networks or protocols. In some embodiments, all or a portion of the communications module 330 may be integrated into a component of the example computer system 300. For example, the communications module may be integrated into a communications chipset. In some embodiments, the communications module 330 may be omitted such as, for example, if sending and receiving communications is not required in a particular application.

The storage module 340 allows the example computer system 300 to store and retrieve data. In some embodiments, the storage module 340 may be formed as part of the memory 320 and/or may be used to access all or a portion of the memory 320. Additionally or alternatively, the storage module 340 may be used to store and retrieve data from persisted storage other than the persisted storage (if any) accessible via the memory 320. In some embodiments, the storage module 340 may be used to store and retrieve data in a database. A database may be stored in persisted storage. Additionally or alternatively, the storage module 340 may access data stored remotely such as, for example, as may be accessed using a local area network (LAN), a wide area network (WAN), a personal area network (PAN), and/or storage area network (SAN). In some embodiments, the storage module 340 may access data stored remotely using the communications module 330. In some embodiments, the storage module 340 may be omitted and its function may be performed by the memory 320 and/or by the processor 310 in concert with the communications module 330 such as, for example, if data is stored remotely. The storage module 340 may also be referred to as a data store.

Software comprising instructions is executed by the processor 310 from a computer-readable medium. For example, a software may be loaded into RAM from persisted storage of the memory 320. Additionally or alternatively, instructions may be executed by the processor 310 directly from ROM of the memory 320.

FIG. 4 depicts a simplified organization of software components stored in the memory 320 of the example computer system 300 (see FIG. 3). As illustrated, these software components include an operation system 400 and an application 410.

The operating system 400 is software. The operating system 400 allows the application 410 to access the processor 310 the memory 320, and the communications module 330 of the example computer system 300 (see FIG. 3). The operating system 400 may be, for example, Google™ Android™, Apple™ iOS™, UNIX™, Linux™, Microsoft™ Windows™, Apple OSX™, or the like.

The application 410 adapts the example computer system 300, in combination with the operating system 400, to operate as a device performing a particular function. For example, the application 410 may cooperate with the operating system 400 to adapt a suitable embodiment of the example computer system 300 to operate as the computer system 110 and/or the computer system 240 (see FIGS. 1 and 2).

In some embodiments in which the computer system 300, or a similar system functions as the first computing device 130, the applications 410 may include a social media application. The social media application may be configured for secure communications with the computer system 110 and may provide various social media functions such as, for example, the ability to send connection requests from a first social media account (source social media account) to a second social media account (target social media account).

By way of another example, in at least one embodiment in which the computer system 300 functions as the first computing device 130, the applications may include a resource account application. The resource account application may be configured for secure communications with the computer system 110 and may provide various resource account functions such as, for example, the ability to display a quantum value in one or more data records, configure or request data transfers, and other account management functions.

Further, in at least one embodiment in which the computer system 300 functions as the first computing device 130, the applications may include a gesture identifying application. The gesture identifying application may use sensor data generated by a sensor of the first computing device to identify a gesture such as a shaking gesture. In some embodiments, the sensor may be an accelerometer. For example, a shaking gesture may be detected using data from an accelerometer of the first computing device 130. Further, in some embodiment, the gesture identifying application may be a social media application or resource account application. That is, identifying a gesture may be a function of the social media application or the resource account application. In other embodiments, the social media application or resource account application may interact with the gesture identifying application to use gesture data generated by the gesture identifying application.

The computer system 110 may provide an application or mobile application that, when downloaded and installed on the first computing device 130, may enable communication between the computer system 110 and the first computing device 130. Specifically, when the application is opened and/or used on the first computing device 130, the computer system 110 may communicate with the first computing device 130 and this may be done to perform one or more actions. For example, a configuration process may be performed that may require the first computing device 130 to authenticate to the computer system 110 using authentication credentials such as a username, a password, a passkey, biometric data, or a combination thereof. The computer system 110 may receive the authentication credentials and may confirm that the authentication credentials are correct by consulting, for example, the database 120 (see FIG. 1). In response, the computer system 110 may identify an account of the account holder. In another example, the computer system 110 may send a signal to the first computing device 130 wherein the signal causes the first computing device 130 to measure or monitor sensor data generated by sensors of the first computing device 130. Additionally or alternatively, the first computing device 130 may share its location with the computer system 110. For example, the first computing device 130 may share its geolocation (obtained via GPS) with the computer system 110. In another example, the first computing device 130 may share, with the computer system 110, the internet protocol (IP) address of a router connected to the first computing device 130.

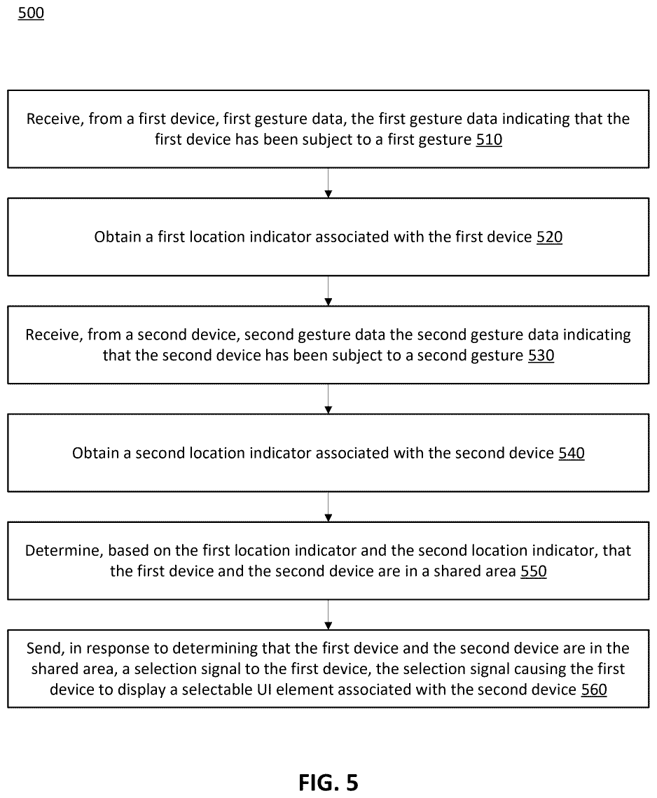

Reference is now made to FIG. 5 which illustrates, in flowchart form, a method 500 for identifying a target device based on sensor data and location data. The method 500 may be implemented by a computing device having suitable processor-executable instructions for causing the computing device to carry out the described operations. The method 500 may be implemented, in whole or in part, by a computer system such as the computer system 110 (see FIG. 1). The computer system may off-load some operations of the method 500 to one or more computing devices such as the computing devices 130, 132, and 134 (see FIG. 1).

The method 500 may begin with a step 510. The step 510 may include receiving, from a first device and via a communications module, first gesture data, the first gesture data indicating that the first device has been subject to a first gesture. In some embodiments, the first device may be the first computing device 130.

In some embodiments, the first gesture may be any motion-related gesture. For example, the first gesture may be a shaking gesture corresponding to a human shaking the first device back and forth in their hand. In another example, the first gesture may be a human using the first device to trace a circle in the air. In yet another example, the first gesture may be a human using the first device to trace a sequence of letters in the air. The occurrence of such motion-related gestures may be detected based on sensor data generated/measured by a sensor coupled to or integrated with the first device. Examples of such a sensor include, without limitation, an accelerometer. In the case of an accelerometer, the sensor data may be acceleration data.

In some embodiments, the first device may monitor its own sensor data using sensor(s) or first sensor(s) coupled to or integrated with the first device (such as the sensors of the sensor module 230 as described herein with reference to FIG. 2). In such embodiments, the first device may determine, based on the sensor data, that the first device has been subject to the first gesture. In response thereto, the first device may send the first gesture data to the computer system. In such embodiments, the first acceleration data may be akin to a signal including information indicating that the first device has detected the first gesture.

In other embodiments, the first device may send sensor data generated or measured by its sensor(s) or first sensor(s) to the computer system. The computer system may then monitor and/or process the received sensor data to determine that the first device has been subject to the first gesture. That is, in these embodiments, the first gesture data received by the computer system may correspond to sensor data generated by the first sensor(s).

In some embodiments, the first device or the computer system may determine that the first device has been subject to the first gesture based on predetermined criteria. For example, the sensor(s) or first sensor(s) of the first device generating sensor data adhering to a pattern that satisfies the predetermined criteria may lead to the first device or computer system to determining that the first device has been subject to the first gesture.

In another embodiment, the first device or the computer system may determine that the first device has been subject to the first gesture by using a machine learning (ML) model. For example, a ML model may be trained to determine if a set of sensor data or a pattern of sensor data corresponds to the first gesture. Upon receiving the first gesture data (sensor data in this embodiment), the computer system may provide the first gesture data, or a portion thereof, to a ML model such as a binary classifier. The ML model may then output a classification for the first gesture data, namely whether the first gesture data corresponds to the gesture or not. That is, the computer system may receive, from the ML model, a gesture indicator, the gesture indicator indicating that the first device has been subject to the first gesture.

Following the step 510, the method 500 may proceed to a step 520. The step 520 may include obtaining a first location indicator associated with the first device. In some embodiments, the first location indicator may be a geolocation or GPS coordinates. For example, the computer system may send a request to the first device for the first device to share or provide its geolocation or GPS coordinates to the computer system. The first device may then determine its geolocation or GPS coordinates using a resident location subsystem such as the location subsystem 234 and send the determined geolocation or GPS coordinates to the computer system (see FIG. 2). In another embodiment, the first location indicator may be an IP address of a router connected to the first device. In this example, the computer system may send a request for the router's IP address to the first device and, in response thereto, the first device may provide the router's IP address to the computer system. Alternatively, in this example, the computer system may determine the router's IP address based on previous communications with the first device. For example, the first device may its share IP address with the computer system at the step 510 wherein the first device provides the first gesture data to the computer system. The computer system may extract the router's IP address from the IP address of the first device.

In some embodiments, the first device may send the first location indicator to the computer system with the first gesture data of the step 510. For example, the first device may detect, by sensor data generated/measured by its sensor(s), that the first device has been subject to the first gesture. In response thereto, the first device may send its geolocation to the computer system in or along with a signal indicating to the computer system that the first device has been subject to the first gesture.

In some embodiments, the computer system may execute or perform the step 520 in response to the step 510. That is, the computer system may determine the first geolocation of the first device in response to receiving the first acceleration data. Additionally or alternatively, the computer system may determine the first geolocation of the first device in response to determining that the first device has been subject to the first gesture.

Following the step 520, the method 500 may proceed to the step 530. The step 530 includes receiving, from a second device and via the communications module, second gesture data, the second gesture data indicating that the second device has been subject to a second gesture. The computer system may execute or perform the step 530 similarly to the step 510 as described herein and as applicable to the second device. Specifically, the second device may be a computing device similar to the first device, such as the second computing device 132. Further, the second gesture data may be sensor data generated/measured by sensor(s) or second sensor(s) integrated with or coupled to the second device. Additionally or alternatively, the second gesture data may be akin to a signal indicating that the second device has detected, based on sensor data generated/measured by its sensor(s) or second sensor(s), that the second device has been subject to the second gesture. The second gesture may correspond to a human shaking the second device back and forth, using the second device to trace a circle, or using the second device to trace a sequence of letters.

Following the step 530, the method 500 may proceed to the step 540. The step 540 includes obtaining a second location indicator associated with the second device. The computer system may execute or perform the step 540 similarly to the step 520 as described herein and as applicable to the second device. In particular, the computer system may request, receive, and/or determine the geolocation of the second device, the GPS coordinates of the second device, and/or the IP address of a router connected to the second device.

Following the step 540, the method 500 may proceed to the step 550. The step 550 may include determining, based on the first location indicator and the second location indicator, that the first device and the second device are in a shared area. In some embodiments, the computer system may determine, based on geolocations or GPS coordinates of the first device and the second device, that the first device and the second device are in the shared area. For example, the shared area may be a geographic area having a radius of 5 meters. Accordingly, in this example, the computer system may determine that the first device and the second device are in the shared area if their geolocations are within 10 meters of each other. In another example, the shared area may be a geographic area around the first device having a radius of 5 meters. In this example, the computer system may determine that the first device and the second device are in the shared area if their geolocations are within 5 meters of each other. In yet further embodiments, the computer system may determine, based on the IP addresses of the routers connected to the first device and the second device, respectively, that the first device and the second device are in the shared area. For example, if the first device and the second device are connected to the same router (as determined by IP address), the computer system may determine that the first device and the second device are in the same area.

In some embodiments, the computer system may execute the step 550 in response to the step 510 and/or the step 540. That is, the computer system may determine that the first device and the second device are in the shared area in response to receiving the first gesture data and/or the second gesture data. In another embodiment (or another perspective), the computer system may execute the steps 520 and 540, respectively, in response to the steps 510 and 530 with the goal of executing the step 550. That is, receiving the first gesture data and/or second gesture data may be considered a catalyst for performing a series of steps wherein the series of steps includes determining that the first device and the second device are in the shared area.

Following the step 550, the method 500 may proceed to the step 560. The step 560 may include sending, a selection signal to the first device, the selection signal causing the first device to display a selectable UI element associated with the second device. For example, the selection signal may cause the first device to display a UI and the UI may include the selectable UI element. The selectable UI element may be, for example, a UI element including an icon, username, identifier, or profile photo associated with the second device or an account, or second account, associated with the second device. For example, in an embodiment wherein the computer system is maintaining a social media service, the first device and the second device may be associated with a first account and a second account respectively. The selectable UI element may include the display of an identifier of the second account such as a profile photo. Selecting the selectable UI element may allow the first device indicate, to the computer system, the second device or second account as a target device or target account of a computing operation over a network such as sending a connection request from the first account to the second account.

It should be appreciated that while the step 560 explicitly discusses causing the first device to display a selectable UI element associated with the second device, the computer system may also send a similar signal to the second device. The similar signal may cause the second device to display a similar selectable UI element associated with the first device. That is, selecting this similar UI element may allow the second device to indicate, to the computer system, the first device or a first account associated with the first account as a target device or target account of a computing operation over a network.

In some embodiments, the computer system may execute or perform the step 560 in response to the step 550. That is, the computer system may send, in response to determining that the first device and the second device are in the shared area, and via the communications module, the selection signal to the first device. It should also be appreciated that sending the selection signal to the first device may be contingent on factors other than the first/second gesture data and the first/second location indicators. For example, sending the selection signal may also be contingent on a time-based factor. For example, the computer system may only send the selection signal to the computer system if the computer system determines that the first gesture and the second gesture occurred within a time threshold. For example, prior to sending the selection signal, the computer system may determine a first time associated with the first gesture. The computer system may then, similarly, determine a second time associated with the second gesture. The computer system may then determine that the first time and the second time are within the time threshold before sending the selection signal to the first device. The time threshold may be, for example, a second, 5 second, or 10 seconds.

In embodiments including time-based conditions, the computer system may determine times, such as the first time and the second time, based on timestamps. For example, in an embodiment wherein the computer system receives a signal (first gesture data) from the first device indicating that the first device has been subject to the first gesture, the computer system may timestamp, as the first time, the time associated with reception of the signal. Additionally or alternatively, the signal may include or be sent along with a first timestamp, recorded by the first device, corresponding to the time that the first device determined that it has been subject to the first gesture. In another example, in an embodiment where the computer system determines, based on the first gesture data (sensor data), that the first device has been subject to the first gesture, the computer system may timestamp, as the first time, the time associated with such determination. Additionally or alternatively, the computer system may timestamp, as the first time, a time associated with the end of the first gesture. For example, if the computer system determines based on sensor data from 2025-02-18, 11:04:32 to 2025-02-18, 11:04:33 that the first device has been subject to the first gesture, the computer system may record 2025-02-18, 11:04:32 or 2025-02-18, 11:04:33 as the first time. Further, in some embodiments, the computer system may determine the first time (second time) associated with the first gesture (second gesture) in response to receiving the first gesture data (second gesture data). Additionally or alternatively, the computer system may determine the first time (second time) associated with the first gesture (second gesture) in response to determining that the first device (second device) has been subject to the first gesture (second gesture).

It is further noted that in some instances, the first gesture data and/or the second gesture data may be referred to as “gesture data.” Likewise, in some instances, the first gesture and/or the second gesture may be referred to as “gesture.”

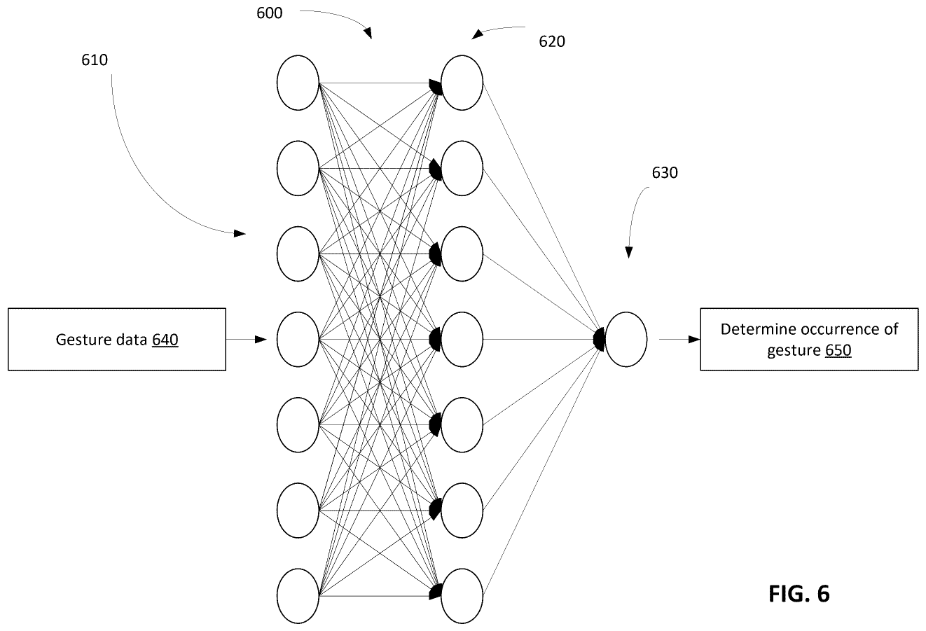

As described with reference to the step 510 of the method 500, in some embodiments, the computer system may determine, based on first gesture data (sensor data) received from the first device, that the first device has been subject to the first gesture. In particular, the computer system may use a ML model to this end. FIG. 6 is a simplified diagram illustrating such an example ML model 600.

The ML model 600 comprises an input layer 610, at least one hidden layer 620, and an output layer 630. While FIG. 6 explicitly shows one hidden layer (the at least one hidden layer 620), the ML model 600 may comprise multiple hidden layers. Further, while FIG. 6 shows a model structure akin to a binary classifier, in other embodiments, the ML model 600 may be another type of model such as an autoencoder.

In operation, the computer system may provide the gesture data 640 to the ML model 600. In some embodiments, the gesture data may be encoded or otherwise transformed, for example by an encoder. The transformed data or measurements may be used as inputs to the input layer 610. Additionally or alternatively, the computer system may generate weightings for the nodes of the input layer 610 by processing the gesture data. In response to receiving inputs to the input layer 610, the ML model may output a probability that the inputted data or measurement correspond to or represent the first gesture (such as a shaking gesture). In an example embodiment, the output layer 630 may comprise a node or weight that represents a probability of the occurrence of the first gesture. The computer system may determine the occurrence of the first gesture based on this probability as shown in block 650 of FIG. 6.

In some embodiments, the ML model 600 may be trained using labelled data. Specifically, the labelled data may comprise sensor data corresponding to a gesture and a label denoting the data as such. Likewise, the labelled data may also comprise sensor data not corresponding to a gesture and a label denoting the data as such.

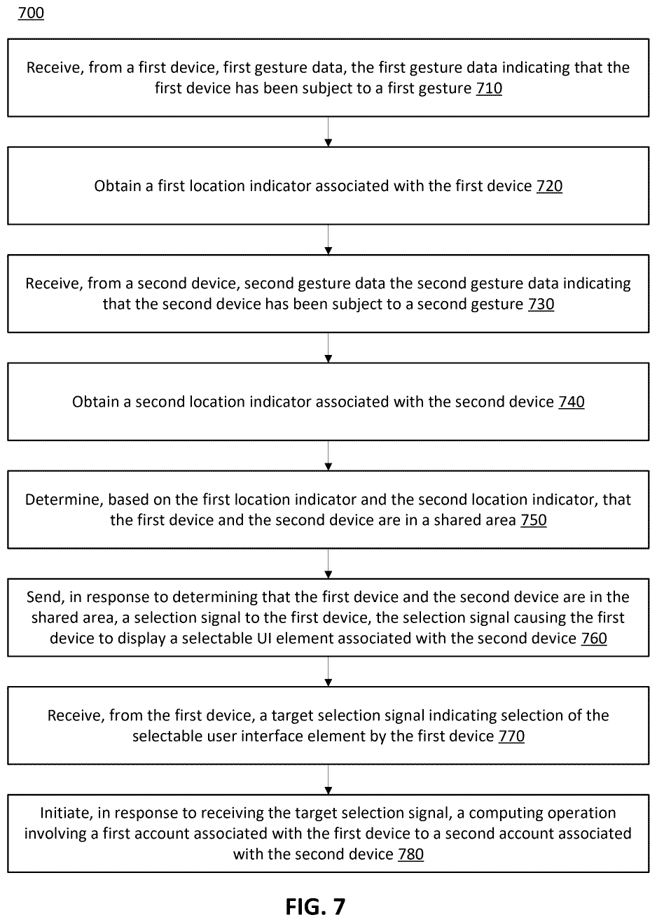

Reference is now made to FIG. 7 which illustrates, in flowchart form, a method 700 for initiating a computing operation in response to identifying a target based on location data. The method 700 may be implemented by a computing device having suitable processor-executable instructions for causing the computing device to carry out the described operations. The method 700 may be implemented, in whole or in part, by a computer system such as the computer system 110 (see FIG. 1). The computer system may off-load some operations of the method 700 to one or more computing devices such as the computing devices 130, 132, and 134 (see FIG. 1).

The method 700 begins with a step 710. The step 710 may include receiving, from a first device, first gesture data, the first gesture data indicating that the first device has been subject to a first gesture. The step 710 may be performed similarly to the step 510 of the method 500 as described herein with reference to FIG. 5.

Following the step 710, the method 700 may proceed to a step 720. The step 720 may include obtaining a first location indicator associated with the first device. The step 720 may be performed similarly to the step 520 of the method 500 as described herein with reference to FIG. 5.

Following the step 720, the method 700 may proceed to a step 730. The step 730 may include receiving, from a second device, second gesture data indicating that the second device has been subject to a second gesture. The step 730 may be performed similarly to the step 530 of the method 500 as described herein with reference to FIG. 5.

Following the step 730, the method 700 may proceed to a step 740. The step 740 may include obtaining a second location indicator associated with the second device. The step 740 may be performed similarly to the step 540 of the method 500 as described herein with reference to FIG. 5.

Following the step 740, the method 700 may proceed to a step 750. The step 750 may include determining, based on the first location indicator and the second location indicator, that the first device and the second device are in a shared area. The step 750 may be performed similarly to the step 550 of the method 500 as described herein with reference to FIG. 5.

Following the step 750, the method 700 may proceed to a step 760. The step 760 may include sending, in response to determining that the first device and the second device are in the share area, a selection signal to the first device, the selection signal causing the first device to display a selectable UI element associated with the second device. The step 760 may be performed similarly to the step 560 of the method 500 as described herein with reference to FIG. 5.

Following the step 760, the method 700 may proceed to a step 770. The step 770 may include receiving, from the first device and via the communications module, a target selection signal indicating selection of the selectable UI element by the first device. For example, a user of the first device may select the selectable UI element by tapping the selectable UI element. In response thereto, the first device may send the target selection signal to the computer system. In some embodiments, selection of the selectable UI element may be considered a selection of the second device, or second account associated with the second device, as a target of a computing operation involving a first account associated with the first device and a second account associated with the second device. Examples of such computing operation include, without limitation, a connection request from the first account to the second account, a data transfer from the first account to the second account, or a request from the first account to the second account, the request being a request for a data transfer from the second account to the first account.

Following the step 770, the method 700 may proceed to a step 780. The step 780 may include initiating, in response to receiving the target selection signal, a computing operation involving the first device, or a first account associated with the first device, and the second device, or a second account associated with the second device. In some embodiments, the computing operation may be a data transfer from the first account to the second account. In such embodiments, initiating the data transfer may comprise requesting the first device to provide a resource quantity to transfer from the first account to the second account. For example, if the initiated data transfer is a transfer of digital tokens from the first account to the second account, the computer system may send a signal (say quantity request signal) to the first device. The sent signal may cause the first device to display an input UI element such as an input box. The input UI element may allow an account holder associated with the first account or first device to input a quantity of digital tokens to transfer to the second account. The sent signal may further cause the first device to display a confirmation button or sliding bar for the account holder associated with the first account or first device to confirm the initiating of the data transfer. In other embodiments, the computing operation may be a connection request (e.g. a follow request on social media).

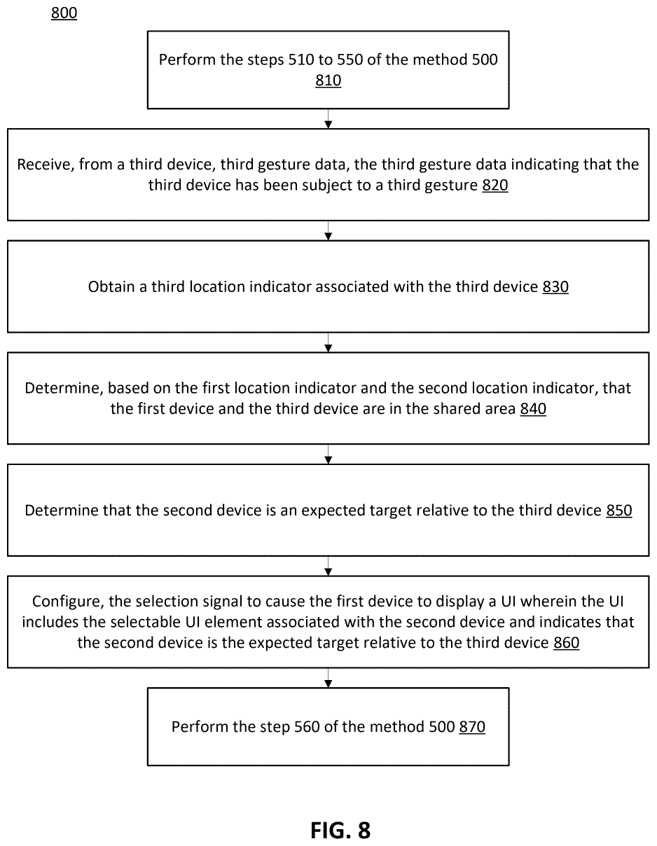

Reference is now made to FIG. 8 which shows, in flow chart form, a method 800 for identifying, among a plurality of potential targets, a preferred target (or expected target) relative to the other potential targets. The method 800 may be implemented by a computing device having suitable processor-executable instructions for causing the computing device to carry out the described operations. The method 800 may be implemented, in whole or in part, by a computer system such as the computer system 110 (see FIG. 1). The computer system may off-load some operations of the method 800 to one or more computing devices such as the computing devices 130, 132, and 134 (see FIG. 1).

The method 800 begins with a step 810. The step 810 may include performing the steps 510 to 550 of the method 500 as described herein with reference to FIG. 5. In particular, the computer system may determine that a first device has been subject to a first gesture, a second device has been subject to a second gesture, and that the first device and the second device are in a shared area.

Following the step 810, the method 800 may proceed to a step 820. The step 820 may include receiving, from a third device and via the communications module, third gesture data, the third gesture data indicating that the third device has been subject to a third gesture. In some embodiments, the third device may be or correspond to the third computing device 134. The step 820 may be performed similarly to the steps 510 and 530, as described herein with reference to FIG. 5, and as applicable to the third device.

Following the step 820, the method 800 may proceed to a step 830. The step 830 may include obtaining a third location indicator associated with the third device. The step 830 may be performed similarly to the steps 520 and 540 as described herein with reference to FIG. 5, and as applicable to the third device.

Following the step 830, the method 800 may proceed to a step 840. The step 840 may include determining, based on the first location indicator and the third location indicator, that the first device and the third device are in the shared area. The step 840 may be performed similarly to the step 550, as described herein with reference to FIG. 5, and as applicable to the third device. In an example, the shared area may be a geographic area around the first device having a radius of 5 meters. In another example, the shared area may be a location allowing the first device and the third device to connect to a router with a particular IP address. It should be appreciated that while in the embodiment shown in FIG. 8, the first device, the second device, and the third device are all in the shared area, in other embodiments, the shared area of the first device and the second device may be different from the shared area of the first device and the third device. That is, the first device and the second device may occupy a first shared area while the first device and the third device may occupy a second shared area different (but not necessarily mutually exclusive) from the first shared area.

Following the step 840, the method 800 may proceed to a step 850. The step 850 may include determining that the second device, or a second account associated with the second device, is an expected target relative to the third device, or a third account associated with the third device. That is, the computer system may determine that the second device, or a second account associated with the second device, is more likely to be a target of a computing operation over a network (e.g., a data transfer or connection request) from the first device, or a first account associated with the first device, than the third device, or a third account associated with the third device. In some embodiments, the computer system may determine that the second device is the expected target relative to the third device based on distance measurements. That is, the computer system may determine that the second device is the expected target by determining, based on the first location indicator, the second location indicator, and the third location indicator, that the first device is spatially closer to the second device than to the third device. For example, the computer system may determine that the second device is the expected target by determining, for example using geolocations or GPS coordinates, that the first device is geographically closer to the second device than to the third device. Additionally or alternatively, the computer system may employ Wi-Fi triangulation techniques to determine that the first device is spatially closer to the second device than to the third device. In other embodiments, the computer system may determine that the second device is the expected device based on timestamps or time data. For example, the computer system may determine that the time between the occurrence of the first gesture and the occurrence of the second gesture is shorter than the time between the occurrence of the first gesture and the occurrence of the third gesture. That is, for example, the computer system may 1) determine a first time associated with the first gesture, 2) determine a second time associated with the second gesture, 3) determine a third time associated with the third gesture, and 4) determine, based on the first time, the second time, and the third time, that the second device is the expected target. In yet further embodiments, the computer system may determine that the second device is the expected target based on a combination of location data/indicators and time data.

In some embodiments, the computer system may determine that the second device is the expected target by using a ML model. For example, the computer system may provide to the ML model, first data associated with the first device, second data associated with the second device, and third data associated with the third device. The ML model may then output a preference indicator wherein the preference indicator indicates the expected target relative to other potential targets (or that the second device is the expected target relative to the third device). That is, the computer system may receive, from the ML model, the preference indicator. In an example, the first data may include, without limitation, a computing operation history associated with the first device, an address associated with the first device, an email address associated with the first device, an identifier of a first account associated with the first device, a name of an account holder associated with the first device, the first location, and a time associated with the first gesture. Similar examples of data apply to the second data and the third data. Examples of a computing operation history may be a data transfer history or a social network use history (e.g. viewed or uploaded social media posts).

It should be appreciated that the preference indicator indicates preference and may not necessarily identify the expected target relative to potential targets as the expected target. For example, in some embodiments, the preference indicator may indicate that a potential target is not the expected target. In a specific example, the preference indicator may indicate that the third device is not the expected target relative to the second device. Further, in some embodiments, the preference indicator may be weightings or probabilities corresponding to the likelihood of a source (first device) selecting a respective target among potential targets (second device and/or third device).

In some embodiments, the ML model may be trained using unsupervised learning. Examples of unsupervised learning methods include, without limitation, K-means clustering. Specifically, the ML model may be trained to recognize patterns of data transfer behaviours. For example, unsupervised learning may train the ML model to recognize, based on a data transfer history associated with the first device, that the first device frequently or regularly initiates data transfers to the second device or that the first device initiates data transfers to the second device more frequently than to the third device. In another example, unsupervised learning may train the ML model to recognize, based on a data transfer history associated with the first device, that the first device makes data transfers to a particular type of business or institution during particular times and the second device is associated with a business of the same type.

It should be appreciated that while the step 850 explicitly mentions determining that, with respect to a computing operation over a network from the first device, the second device is an expected target relative to the third device, the computer system may also make similar determinations for computing operations over a network from the second device or third device. For example, the computer system may determine that one of the first device and the third device is the expected target of a connection request from the second device. In another example, the computer system may determine that one of the first device and the second device is the expected target of a data transfer from the third device.

Following the step 850, the method 800 may proceed to a step 860. The step 860 may include configuring, based on the second device being the expected target relative to the third device, the selection signal to cause the first device to display a UI wherein the UI includes the selectable UI element associated with the second device. Further, the UI may indicate, in response to determining that the second device is the expected target relative to the third device, that the second device is the expected target relative to the third device. In some embodiments, the UI may indicate that the second device is the expected target relative to the third device by biassing selection of the selectable UI element associated with the second device. For example, in response to determining that the first device and the third device are in the shared area, the UI may be configured to include an additional selectable UI element associated with the third device. The UI may then be configured to bias selection of the selectable UI element over the additional selectable UI element by, for example, enlarging the selectable UI element relative to the additional selectable UI element. That is, the selectable UI element may occupy more space, or a larger area, of the UI than the additional selectable UI element. In another example, the computer system may cause the UI to bias selection of the selectable UI element over the additional selectable UI element by displaying the selectable UI element and the additional selectable UI element in a list wherein the selectable UI element is placed before the additional selectable UI element within the list. For example, in the case of a vertical list, the selectable UI element may be placed above the additional selectable UI element. In another embodiment, the computer system may configure the UI to indicate that the second device is the expected target relative to the third device by not including, in the UI, an additional selectable UI element associated with the third device. In this embodiment, the first device may be unable to select the third device as a target device.

It should be appreciated that while the description of the step 860 discusses causing the first device to display a UI that biases selection of the selectable UI element associated with the second device over the additional selectable UI element associated with the third device, the computer system may perform a similar step or operation with respect to the second device or the third device. For example, the computer system may cause the second device to display a UI that biases selection of a UI element associated with one of the first device and the third device over a UI element associated with the other of the first device and the third device. Likewise, the computer system may cause the third device to display a UI that biases selection of a UI element associated with one of the first device and the second device over a UI element associated with the other of the first device and the second device.

It should further be noted that in some instances, the computer system may not cause the second device or the third device to display UI elements associated with the other. For example, the second location indicator and the third location indicator may indicate that the second device and the third device are not in a shared area (or third shared area). For example, if 1) “shared areas” were defined as geographic areas having radius 5 meters, 2) the first device, the second device, and the third device are in a geometric line wherein the first device is between the second device and the third device, 3) the first device is 4 meters away from the second device, and 4) the first device is 7 meters away from the third device, then the second device and the third device would not be in a defined shared area because they are 11 meters apart. Additionally or alternatively, in examples where time is a condition to causing devices to display a particular UI, (such as the first gesture and the second gesture occurring within a time threshold), the second gesture and the third gesture may be separated by too much time for the second device and the third device to display UI elements associated with each other.

Following the step 860, the method 800 may proceed to a step 870. The step 870 may include performing the step 560 of the method 500. It should be noted that the computer system may perform the steps 820 to 860 prior to sending the selection signal to the first device. That is, the computer system may, prior to sending the selection signal to the first device, receive the third gesture data, obtain the third location indicator, determine that the first device and the third device are in a second shared area, determine that the second device is an expected target relative to the third device, and configure the selection signal.

It is noted that in some instances, the third gesture data may be referred to as “gesture data.” Likewise, in some instances, the third gesture may be referred to as “gesture.”

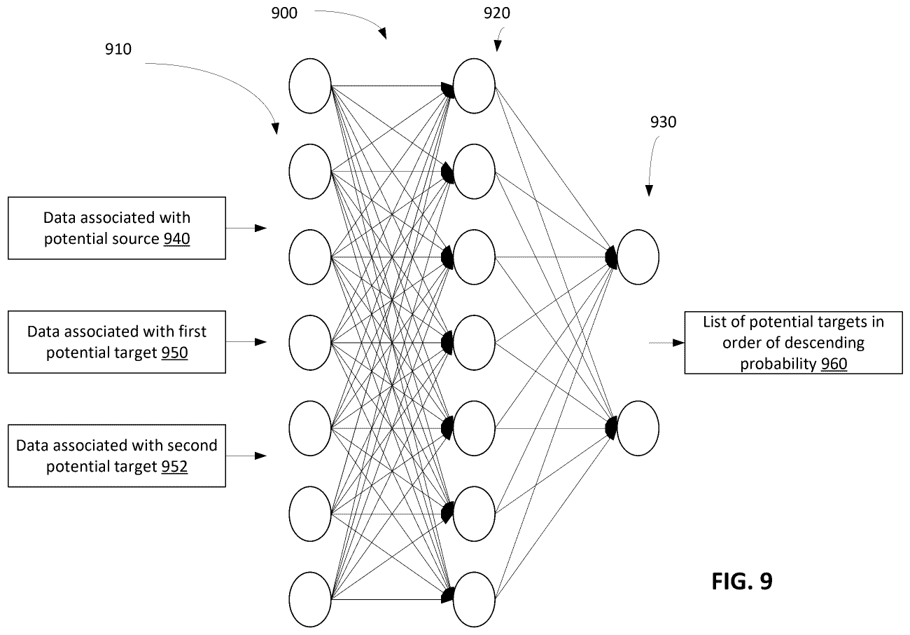

As discussed with reference to the step 860, the computer system may use a ML model to determine that the second device is the expected target. FIG. 9 is a simplified diagram illustrating such an example ML model 900.

The ML model 900 comprises an input layer 910, at least one hidden layer 920, and an output layer 930. While FIG. 9 explicitly shows one hidden layer (the at least one hidden layer 920), the ML model 900 may comprise multiple hidden layers.

In operation, as shown in the block 940, the computer system may provide data associated with a source (e.g., the first device) as an input to the ML model 900. Further, as shown in the blocks 950 and 952, the computer system may provide data associated with a first potential target (e.g., the second device) and a second potential target (e.g., the third device) to the ML model 900. While FIG. 9 shows two potential targets, the ML model 900 may be trained to process or receive data associated with any number of potential targets of an operation over a network from the source. The data associated with the source or potential targets may include, without limitation, identifiers associated with accounts, computing operation histories associated with accounts, addresses associated with accounts, and emails associated with accounts.

In some embodiments, the data provided to the ML model 900 may be encoded or otherwise transformed, for example by an encoder. The transformed data may be used as inputs to the input layer 910. Additionally or alternatively, the computer system may generate weightings for the nodes of the input layer 910 by processing the data associated with the source and/or potential targets. In response to receiving inputs to the input layer 910, the ML model may output a probability for each potential target wherein the probability is the probability that the source will select or identify the potential target as a target. In some embodiments, a node of the output layer 930 may represent a probability of a corresponding potential target being selected as the target. As shown in the block 960, the computer system may, based on the output of the ML model 900, generate a list of potential targets in order of descending probability.

In some embodiments, the ML model 900 may be trained via unsupervised learning techniques such as K-means clustering. For example, sample patterns of data transfer histories may be used to train the ML model 900 to predict a target of a data transfer given a data transfer history of a source.

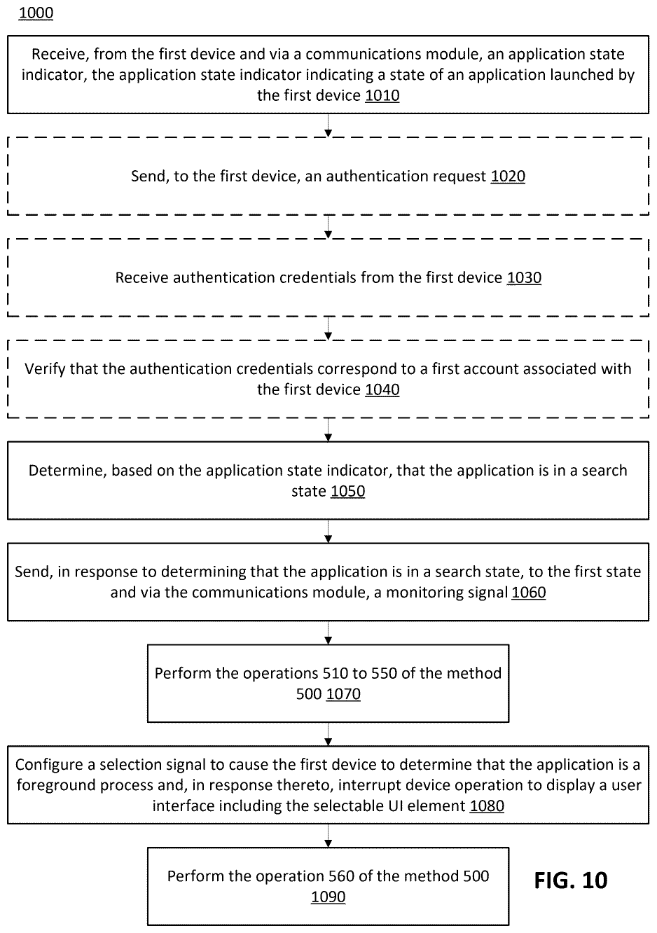

Reference is now made to FIG. 10 which shows, in flowchart form, a method 1000 for using an application and sensor data to identify a target based on location data. The method 1000 may be implemented by a computing device having suitable processor-executable instructions for causing the computing device to carry out the described operations. The method 1000 may be implemented, in whole or in part, by a computer system such as the computer system 110 (see FIG. 1). The computer system may off-load some operations of the method 1000 to one or more computing devices such as the computing devices 130, 132, and 134 (see FIG. 1).

The method 1000 begins with a step 1010. The step 1010 may include receiving, from a first device and via the communications module, an application state indicator, the application state indicator indicating a state of an application launched by the first device. The application may be an application maintained by the computer system. Further, the application may enable the first device to engage in computing operations over a network such as connection requests or data transfers. The state indicated by the application state indicator may be, for example, that the application is open on the first device, that the application has just been launched on the first device, or that the application on the first device has been navigated to a particular page (e.g. a “search” page such as a page that could be used to search for connections on social media).

Following the step 1010, the method 1000 may proceed to an optional step 1020. The optional step 1020 may include, sending to the first device, an authentication request. In some embodiments, the computer system may execute or perform the optional step 1020 in response to the step 1010. That is, the computer system send the authentication request in response to receiving the application state indicator. For example, in the case that the application state indicator indicates that the application was just launched, in response to receiving the application state indicator, the computer system may request authentication credentials.

Following the optional step 1020, the method 1000 may proceed to the optional step 1030. The optional step 1030 may include receiving authentication credentials from the first device. The authentication credentials may include, without limitation, a username, a password, a passkey, a passphrase, biometric data, or a combination thereof. In some embodiments, the first device may send the authentication credentials to the computer system in response to receiving, from the computer system, the authentication request.

Following the optional step 1030, the method 1000 may proceed to the optional step 1040. The optional step 1040 may include verifying that the authentication credentials correspond to a first account associated with the first device. To this end, the computer system may perform a lookup operation in a database such as the database 120 (see FIG. 1). That is, in an example embodiment, the computer system may verify that the received authentication credentials match authentication credentials stored in association with the first account or the first device. In some embodiments, the computer system may execute or perform the optional step 1040 in response to the optional step 1030. That is, the computer system may verify the authentication credentials in response to receiving the authentication credentials.

It should be appreciated that while FIG. 10 shows the optional steps 1020-1040 being performed after the steps 1010, in some embodiments, the step 1010 may be performed after the optional steps 1020-1040. Such may be the case, for example, when the application state indicator indicates that the application has been navigated to a “search” page on the first device.

Following the optional step 1040, the method 1000 may proceed to a step 1050. The step 1050 may include determining, based on the application state indicator, that the application is in a search state. In some embodiments, the search state may be that the application has navigated to a “search” page on the first device. In other embodiments, the search state may correspond to the application being a foreground process of the first device. In other embodiments, the search state may correspond to the application being open on the first device and past authentication procedures (i.e. the first device has been authenticated/verified).

Following the step 1050, the method 1000 may proceed to a step 1060. The step 1060 may include sending, in response to determining that the application is in the search state, to the first device and via the communications module, a monitoring signal. The monitoring signal may cause a sensor of the first device to monitor motion of the first device. Further, in some embodiments, the monitoring signal may cause the first device to send the first gesture data, as described herein with reference to the step 510 of the method 500 as shown in FIG. 5, to the computer system. It should be noted that the computer system may execute or perform the optional steps 1030 and 1040 prior to the step 1060. That is, the computer system may receive and verify the authentication credentials received from the first device prior to sending the monitoring signal to the first device.

Following the step 1060, the method 1000 may proceed to a step 1070. The step 1070 may include performing the steps 510 to 550 of the method 500 as described herein with reference to FIG. 5. It should be noted that the computer system may execute or perform the steps 1010 and 1060 prior the step 1070. That is, the computer system may, prior to receiving the first gesture data, receive the application state indicator and send the monitoring signal.

Following the step 1070, the method 1000 may proceed to a step 1080. The step 1080 may include configuring a selection signal. The selection signal may be configured to cause the first device to determine that the application is a foreground process. The selection signal may further be configured to interrupt, in response to determining that the application is the foreground process, device operation of the first device and cause the first device to display a UI including a selectable UI element associated with the second device. That is, receiving the selection signal, as configured in the step 1080, may cause the first device to halt operation to display the UI and the selectable UI element if the application is running on the first device as a foreground process.

Following the step 1080, the method 1000 may proceed to a step 1090. The step 1080 may include performing the step 560 of the method 500 as described herein with reference to FIG. 5. That is, the computer system may send the selection signal, as configured, to the first device.

It should be appreciated that while the method 1000 is discussed using the term “first device,” “first device” is intended to be non-limiting. For example, depending on the context, the method 1000 may be performed with respect to a “second device” or “third device.”

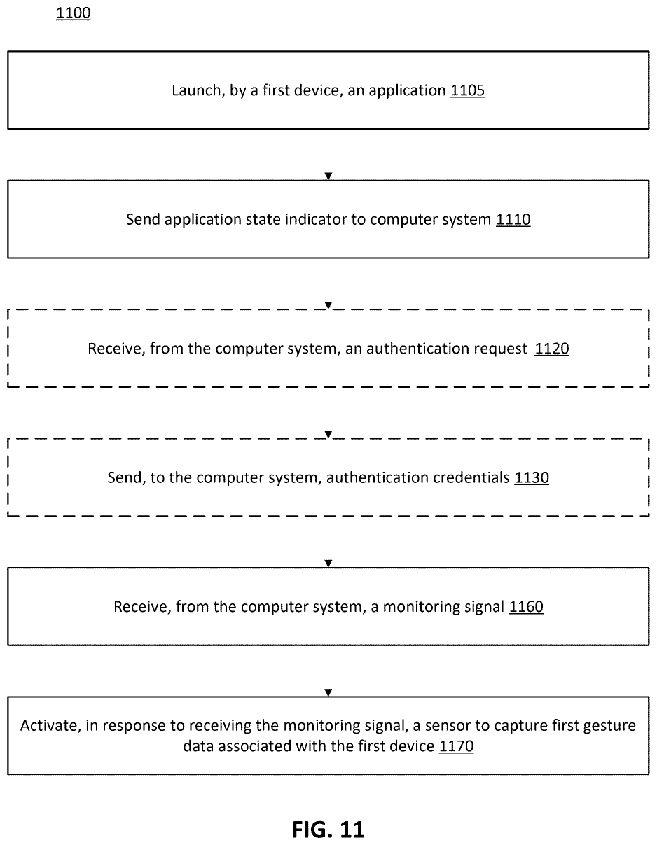

Reference is now made to FIG. 11 which shows, in flowchart form, a method 1100 for activating a sensor of a computing device such as one of the computing devices 130, 132, and 134 (see FIG. 1). The method 1100 may be implemented by a computing device having suitable processor-executable instructions for causing the computing device to carry out the described operations. The method 1100 may be implemented, in whole or in part, by a computing device such as the first computing device 130. It should be appreciated that the method 1100 may be performed in parallel with the method 1000 as described herein with reference to FIG. 10. Specifically, the first computing device 130 may execute or perform the method 1100 while the computer system 110 performs the method 1000 (see FIG. 1).

The method 1100 may begin with a step 1105. The step 1105 may include launching, by a first device, such as the first computing device 130, an application. Following the step 1105, the method 1100 may proceed to a step 1110 wherein the first device sends an application state indicator to a computer system such as the computer system 110. In some embodiments, the first device may send the application state indicator in response to launching or detecting the launching of the application. In such embodiments, the application state indicator may indicate that the application has just been launched on the first device. The application may be maintained by the computer system.

Following the step 1110, the method 1100 may proceed to an optional step 1120. The optional step 1120 may include receiving, from the computer system, an authentication request. In some embodiments, as described herein with reference to the optional step 1020 of the method 1000, the computer system may send the authentication to the first device in response to receiving the application launch signal from the first device.

Following the optional step 1120, the method 1100 may proceed to an optional step 1130. The optional step 1130 may include sending, to the computer system, authentication credentials. The authentication credentials may include, without limitation, a username, a password, a passkey, a passphrase, and/or biometric data. In some embodiments, the first device may send the authentication credentials to the computer system in response to receiving the authentication request.

It should be appreciated that while FIG. 11 shows the step 1110 being performed prior to the optional steps 1120-1130, in some embodiments, the step 1110 may be performed after the optional steps 1120-1130. For example, after being authenticated, the first device may navigate to a “search” page on the application. In response thereto, the first device may send the application state indicator to the computer system wherein the application state indicator indicates that the application is in a search state on the first device.

Following the optional step 1130, the method 1100 may proceed to a step 1160. The step 1160 may include receiving, from the computer system a monitoring signal. As described herein with reference to the step 1060 of the method 1000, the monitoring signal may cause a sensor of the first device to monitor motion of the first device. Further, in some embodiments, the monitoring signal may cause the first device to send the first gesture data, as described herein with reference to the step 510 of the method 500 as shown in FIG. 5, to the computer system.

Following the step 1160, the method 1100 may proceed to a step 1170. The step 1160 may include activating, in response to receiving the monitoring signal, the sensor to detect motion of the first device. Specifically, the sensor may generate/measure data relating to motion of the first device.

It should be appreciated that while the method 1100 is discussed using the term “first device,” “first device” is intended to be non-limiting. That is, depending on the context, a “second device” or “third device” may perform the method 1100.

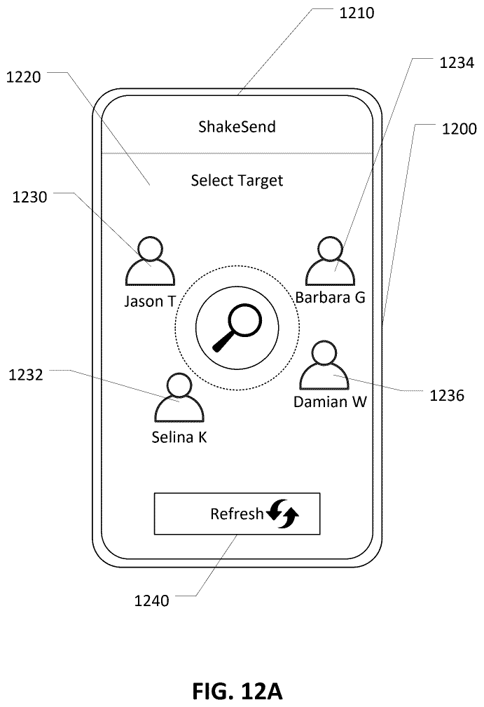

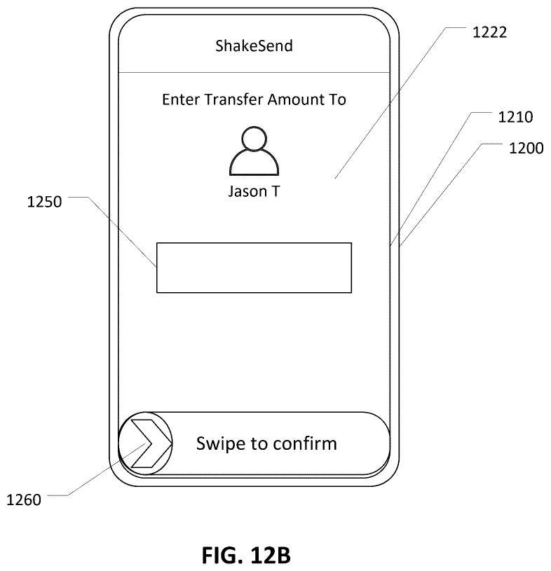

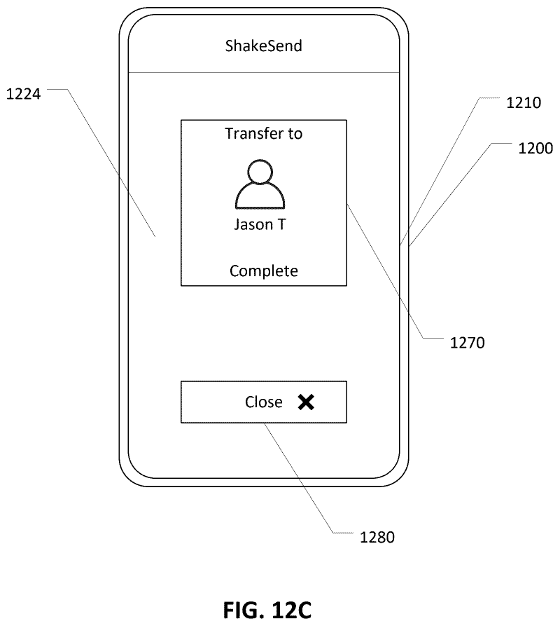

Reference is now made to FIGS. 12A-12C which show an example computing device 1200 presenting, on a display 1210, a UI for computing operations initiated by detection of a gesture associated with the computing device 1200. The UI may be part of an application maintained by a computer system such as the computer system 110 (see FIG. 1). Further, the application may support computing operations over a network from a source to a target such as a data transfer or connection request. FIG. 12A shows a UI 1220 which the computing device 1200 may display in response to receiving a signal akin or similar to the selection signal as discussed with reference to the step 560 of the method 500, the step 760 of the method 700, the step 870 of the method 800, and the step 1090 of the method 1000. The UI 1220 is shown including selectable UI elements 1230, 1232, 1234, and 1236. The selectable UI elements 1230, 1232, 1234, and 1236 are shown to be icons or profile photos that identify potential target devices (such as the second device or third device as described with reference to the method 500 as shown in FIG. 5 or the method 800 as shown in FIG. 8) or accounts associated with the potential target devices. That is, any one of the selectable UI elements 1230, 1232, 1234, and 1236 may correspond to the selectable UI element or additional selectable UI element as described herein with reference to the method 500 or the method 800. Selecting one of the selectable UI elements 1230, 1232, 1234, and 1236 may correspond to a selection or identification of the corresponding potential target device or account as a target device or account for an operation over a network such as data transfer. Additionally or alternatively, selecting the one of the selectable UI elements 1230, 1232, 1234, and 1236 may cause initiation of a computing operation involving the computing device 1200 and the selected target. In the specific embodiment shown in FIG. 12A, the computing operation is a data transfer to be initiated from the computing device 1200, or an account associated thereof, to the corresponding target. Put another way, selecting the one of the selectable UI elements 1230, 1232, 1234, and 1236 may cause the computing device 1200 to send, to the computer system maintaining the application, a signal akin to the target selection signal of step 770 of the method 700 as described herein with reference to FIG. 7

The UI 1220 is further shown including a refresh button 1240. Selecting the refresh button may cause the computing system maintaining the application to search again for potential target devices. That is, selecting the refresh button may cause the computer system to perform operations as if the computer system has determined that the computing device 1200 has been subject to a gesture such as the first gesture (as described herein with reference to the method 500). Put another way, selecting the refresh button may be akin to sending a search request to the computer system maintaining the application.

FIG. 12B shows a UI 1222 which the computing device 1200 may display in response to the computer system initiating a data transfer from the computing device 1200, or an account associated thereof, to a target. In the situation shown in FIG. 12B, the target is a target device, or associated target account, selected by selecting the selectable UI element 1230. The UI 1222 is shown including an input box 1250. A transfer amount for the initiated data transfer may be input into the input box 1250. FIG. 12B further shows the UI 1222 including a sliding bar 1260. The sliding bar 1260 may be used to confirm the initiated data transfer.

FIG. 12C shows a UI 1224 which corresponds to a confirmation screen for the data transfer. After the data transfer is confirmed, by sliding the sliding bar 1260 in FIG. 12B, the computer system may perform the confirmed data transfer. Upon completion of the data transfer, the computer system may send a signal causing the computing device 1200 to display the UI 1224. The UI 1224 may include a confirmation message 1270 confirming that the data transfer is complete. The UI 1224 further includes a close button 1280. Selecting the close button 1280 may allow the computing device 1200 to close or escape from the confirmation screen shown in the UI 1224.

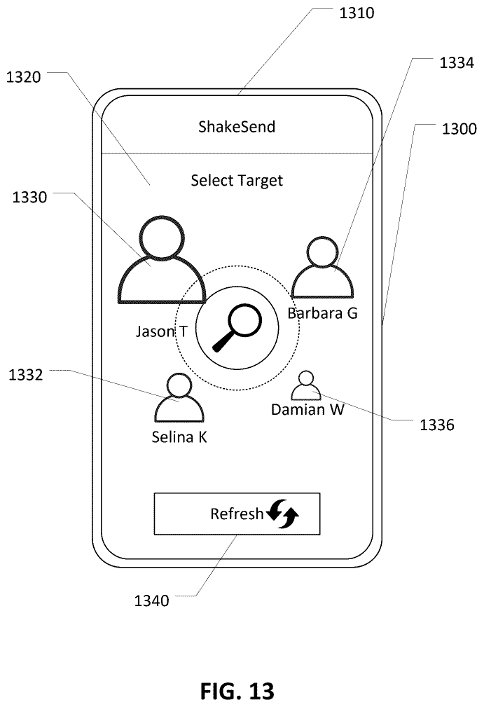

FIG. 13 shows another example computing device 1300 presenting, on a display 1310, a UI 1320 for computing operations initiated by detection of a gesture. The UI 1320 is similar to the UI 1220 as described with reference to FIG. 12A. The UI 1320 is different from the UI 1220 in that the UI 1320 is configured to bias selection of some of the selectable UI elements 1330, 1332, 1334, and 1336 over others. The UI 1320 biases selection of some of the selectable UI elements 1330, 1332, 1334, and 1336 by adjusting their sizes. For example, the selectable UI element 1330 is enlarged relative to the selectable UI element 1334, thereby biasing selection of the selectable UI element 1330 over the selectable UI element 1334. Likewise, selection of the selectable UI element 1334 is biased over the selectable UI elements 1332 and 1336. Selection of the selectable UI elements 1330, 1332, 1334, and 1336 may be biased according to the method 800 as described herein with reference to FIG. 8. The refresh button 1340 operates similarly to the refresh button 1240 as described herein with reference to FIG. 12A.

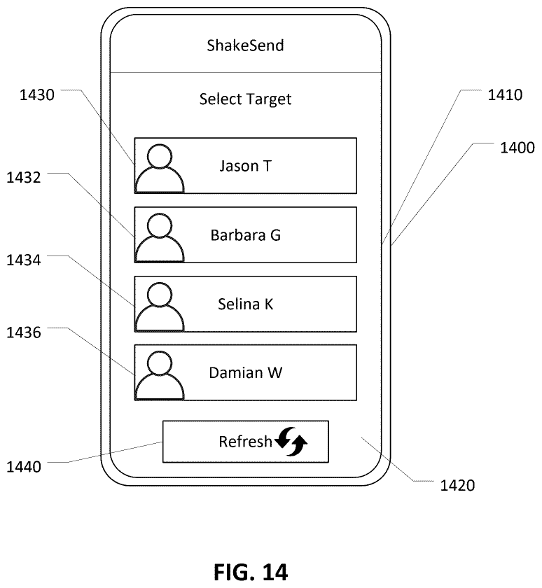

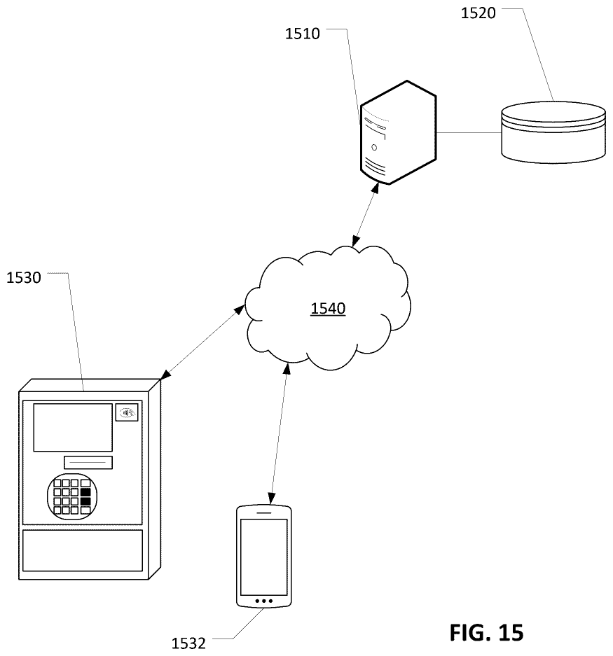

FIG. 14 shows another example computing device 1400 presenting, on a display 1410, a UI 1420 for computing operations initiated by a detection of a gesture. Similar to the UI 1220 and the UI 1320 (see FIGS. 12A and 13), the UI 1420 includes selectable UI elements 1430, 1432, 1434, and 1436. The UI 1420 also includes a refresh button 1440. The UI 1420 biases selection of the selectable UI elements 1430, 1432, 1434, and 1436 according to their order of appearance. That is, selection of the selectable UI element 1430 is biased over the selectable UI elements 1432, 1434, and 1436. Likewise, selection of the selectable UI element 1432 is biased over the selectable UI elements 1434 and 1436.

Reference is now made to FIG. 15 which is a schematic operation diagram illustrating an operating environment of an example embodiment. The embodiment shown in FIG. 15 may be considered a more specific implementation of the embodiment shown in FIG. 1. As shown, the operating environment includes a computer system 1510 (illustrated as a server), a database 1520 coupled to the computer system 1510, a first computing device 1530, a second computing device 1532, and a network 1540 connecting the computer system 1510 to the computing devices 1530 and 1532. The computer system 1510 and the computing devices 1530 and 1532 may be in geographically disparate locations. Put differently, the computer system 1510, and the computing devices 1530 and 1532 may be located remote from one another.

The computer system 1510 may maintain a database 1520 that includes various data records. For example, the computer system 1510 may be a financial institution server which maintains bank accounts. In this example, a data record may, for example, reflect an amount of value stored in a particular account associated with a user. The amount of value may include a quantity of currency.

The database 1520 may include data records for a plurality of resource accounts and at least some of the data records may define a quantity of resources associated with an account holder. For example, an account holder associated with the second computing device 1532 may be associated with one or more resource accounts having one or more data records in the database 1520. The data records may reflect a quantity of resources that are available to the account holder. Such resources may include owned resources (e.g. digital tokens) and, in at least some embodiments, borrowed resources (e.g. resources available on credit). The quantity of resources that are available to or associated with an account holder may be reflected by a balance defined in an associated data record such as, for example, a digital token balance or bank balance. The resource accounts may include, for example, a token account, a digital wallet account, a mobile data account, a chequing account, a savings account, a borrowing account such as for example a line of credit account, a credit card account, a loyalty point account, etc. As such, at least some of the data records may define a chequing account balance, a savings account balance, a line of credit account balance, a credit card account balance, a loyalty point account balance, etc.

The database 1520 may additionally include data records for storing identity data of account holders. The identity data may include, for example, a name, an email address, a social security number, an address, a phone number, etc. of the account holder. The identity may include identity data previously obtained to fulfill know-your-customer (KYC) requirements. The database 1520 may store additional information such as authentication data such as usernames and corresponding passwords. Additionally or alternatively, the database 1520 may store an indication that one or more computing devices have passkeys installed thereon. The database 1520 may further store one or more passkeys that may be used to authenticate an account holder or computing device.

The first computing device 1530 may be a computer system that may communicate with the computer system 1510. The first computing device 1530 may interact with the computer system 1510 to perform tasks such as, for example, performing computing operations over a network, managing account holder data and executing authentication procedures. In the embodiment shown in FIG. 15, the first computing device 1530 is an automated teller machine.

The second computing device 1532, similar to the computing devices 130, 132, and 134 as described herein with reference to FIG. 1, may take a variety of forms including, for example, a mobile communication device such as a smartphone, a tablet computer, a wearable computer (such as a head-mounted display or smartwatch), a laptop or desktop computer, or a computing device of another type.

The computing devices 1530 and 1532 may store software instructions that cause the computing devices 1530 and 1532 to establish communications with the computer system 1510. In some instances, the computing devices 1530 and/or 1532 may execute or perform these communications using an application maintained by the computer system 1510.

In the embodiment shown in FIG. 15, the computing devices 1530 and 1532 may form a connection to perform computing operations. For example, the first computing device 1530 may send a search request, for example in response to user input, to the computer system 1510. At around the same time, occurrence of a second gesture may be detected by a sensor of the second computing device 1532. Upon detecting the occurrence of the second gesture, the second computing device 1532 may send to the computer system 1510, second gesture data that indicates to the computer system 1510 that the second gesture was detected. The computer system 1510 may then determine, for example using GPS coordinates of the first computing device 1530 and the second computing device 1532, that the computing devices 1530 and 1532 are in a shared area. In response thereto, the computer system 1510 may initiate a computing operation involving the computing devices 1530 and 1532. The computing operations may be, for example, forming a connection between the computing devices 1530 and 1532 wherein the first computing device 1530 can be manipulated by a UI displayed on the second computing device. Additionally or alternatively, the computing operation may be sending an authorization request to the first computing device 1530. Receiving a confirmation of the authorization request from the first computing device 1530 may allow the computer system 1510 to enable the second computing device 1532 to operate the first computing device 1530 from a UI displayed on the second computing device 1532. Using the source/target language, it may be said that the second computing device 1532 is a target of the computing operation and the first computing device 1530 is a source of the computing operation. That is, the first computing device 1530 is a source that grants authorization to control the first computing device 1530 and the second computing device 1532 is a target that receives authorization to control the first computing device 1530.

The computing devices 1530 and 1532 may be adapted to present a UI that allows for communication with the computer system 1510 and/or each other. For example, the first computing device 1530 may be adapted to receive, from the computer system 1510, a signal that causes the first computing device 1530 to display a UI. The displayed UI may include a selectable UI element associated with the second computing device 1532 wherein selecting the selectable UI element grants permission to the second computing device 1532 to, at least partially, operate the first computing device 1530. Additionally or alternatively, the second computing device 1532 may be adapted to receive, from the computer system 1510, a signal that causes the second computing device 1532 to display a UI of an application maintained by the computer system 1510. The displayed UI may include a selectable UI element associated with the first computing device 1530 wherein selecting the selectable UI element grants permission to the second computing device 1532, to at least partially, operate the first computing device 1530.

It should be appreciated that FIG. 15 illustrates a non-limiting example embodiment. While FIG. 15 illustrates the computer system 1510 as a single server. In some embodiments, the computer system 1510 may comprise a plurality of servers such as pooled cloud computing services. Likewise, while FIG. 15 illustrates two computing devices 1530 and 1532, in other embodiments, the operating environment may include more such computing devices.

The network 1540 may be a computer network. In some embodiments, the network 1540 may be an internetwork such as may be formed of one or more interconnected computer networks. For example, the network 1540 may be or may include an Ethernet network, an asynchronous transfer mode (ATM) network, a wireless network, a telecommunications network, or the like.

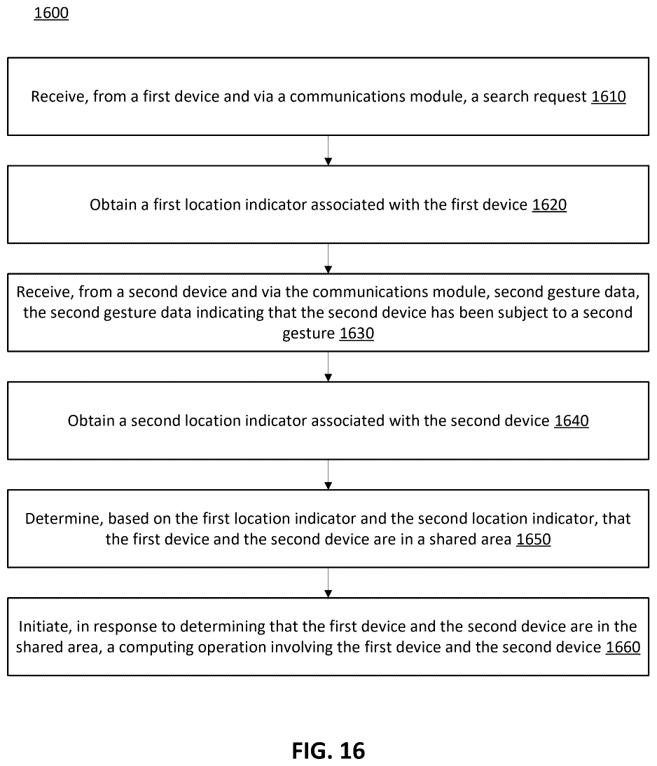

Reference is now made to FIG. 16 which illustrates, in flowchart form, an example method 1600 for initiating a computing operation based on sensor data and location. The method 1600 may be implemented by a computing device having suitable processor-executable instructions for causing the computing device to carry out the described operations. The method 1600 may be implemented, in whole or in part, by a computer system such as the computer systems 110 and 1510 (see FIGS. 1 and 15). The computer system may off-load some operations of the method 500 to one or more computing devices such as the computing devices 130, 132, 134, 1530 and 1532 (see FIGS. 1 and 15).

The method 1600 begins with a step 1610. At the step 1610, the processor may receive, from a first device and via a communications module, a search request. In some embodiments, the step 1610 may be similar to the step 510 of the method 500 as described herein with reference to FIG. 5. That is, receiving the search request may comprise receiving, from the first device, the first gesture data wherein the first gesture data indicates that the first device has been subject to a first gesture. In other embodiments, the search request may be a signal received from, for example, an automated teller machine (in this case the automated teller machine is the first device). For example, a search function may be activated by pressing a “search” button/UI element of the automated teller machine. In response thereto, the automated teller machine (first device) may send the search request to the computer system.

Following the step 1610, the method 1600 may proceed to a step 1620. At the step 1620, the processor may obtain a first location indicator associated with the first device. The processor may perform the step 1620 similarly to the step 520 of the method 500 as described herein with reference to FIG. 5.

Following the step 1620, the method 1600 may proceed to a step 1630. At the step 1630, the processor may receive, from a second device and via the communications module, second gesture data, the second gesture data indicating that the second device has been subject to a second gesture. The processor may perform the step 1630 similarly to the step 530 of the method 500 as described herein with reference to FIG. 5.

Following the step 1630, the method 1600 may proceed to a step 1640. At the step 1640, the processor may obtain a second location indicator associated with the second device. The processor may perform the step 1640 similarly to the step 540 of the method 500 as described herein with reference to FIG. 5.

Following the step 1640, the method 1600 may proceed to a step 1650. At the step 1650, the processor may determine, based on the first location indicator and the second location indicator, that the first device and the second device are in a shared area. The processor may perform the step 1650 similarly to the step 550 of the method 500 as described herein with reference to FIG. 5.

Following the step 1650, the method 1600 may proceed to a step 1660. At the step 1660, the processor may initiate, in response to determining that the first device and the second device are in the shared area, a computing operation involving the first device and the second device. The computer operation may be, for example, connecting the first device to the second device. In some embodiments, upon establishing the connection, the second device may be able to operate the first device from a UI displayed on the second device. To this end, the processor may perform operations similar to the step 560 of the method 500 as described herein with reference to FIG. 5. That is, the computing operation may be sending a selection signal to the first device wherein the selection signal causes the first device to display a selectable UI element associated with the second device. For example, if the first device is an automated teller machine, the selectable UI element may be a tappable button reading “do you wish to connect to [device ID]?” wherein [device ID] is an identifier for the second device. In this example, selecting the selectable UI element may cause the first device to send, to the computer system, a target selection signal indicating selection of the selectable UI element. The processor may receive, from the first device and via the communications module, the target selection signal indicating selection of the selectable UI element by the first device. In response thereto, the processor may enable a connection between the first device and the second device that allows the second device to operate the first device. While the example discussed has the processor sending the selection signal to the first device, in another example, the processor may send the selection signal to the second device. For example, the selection signal may cause the second device to display a selectable UI element reading “do you wish to connect to ATM?” Selecting the selectable UI element may allow the second device to operate the automated teller machine from a UI displayed on the second device. In this described example, the second device may be considered a target that receives operation control of the first device and the first device may be considered a source that gives operation control of itself.

It should be appreciated that while the example raised with respect to the computing operation of the step 1660 relate to connecting the first device and the second device, the example is a non-limiting example. For example, the computing operation may be connecting a first account associated with the first device to a second account associated with the second device. In another example, the computing operation may be a data transfer from the first device/account to the second device/account. In another example, the computing operation may be sending a message or notification from the first device to the second device.

It should further be appreciated that the method 1600 may be performed in parallel or simultaneously (with possible overlap) to a method similar to the method 800 as described herein with reference to FIG. 8. Hence, in some embodiments, there may be an additional potential target (third device) of the computing operation. Detecting a third gesture associated with the third device and determining that the third device is also in the shared area may cause the processor to send a selection signal to the first device. The selection signal may be configured to cause the first device to display a UI including a selectable UI element associated with the second device and an additional selectable UI element associated with the third device.

It should further be appreciated that there may be time-based factor(s) to initiating the computing operation. For example, prior to initiating the computing operation, the processor may 1) determine a first time associated with the receiving of the search request, 2) determine a second time associated with the second gesture, and 3) determine that the first time and the second time are within a time threshold. The time-based factor(s) may be similar to the time-based factors as described herein with reference to the methods 500 or 800 (see FIGS. 5 and 8).

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A computer system, the computer system comprising:
a processor;
a communications module coupled to the processor;
a memory coupled to the processor, the memory storing instructions that, when executed by the processor, configure the processor to:
receive, from a first device and via the communications module, a search request;
obtain a first location indicator associated with the first device;
receive, from a second device and via the communications module, gesture data, the gesture data indicating that the second device has been subject to a gesture;
obtain a second location indicator associated with the second device;
determine, in response to receiving the gesture data, based on the first location indicator and the second location indicator, that the first device and the second device are in a shared area; and
initiate, in response to determining that the first device and the second device are in the shared area, a computing operation involving the first device and the second device.

2. The computer system of claim 1 wherein receiving the search request further comprises receiving, from the first device and via the communications module, first gesture data, the first gesture data indicating that the first device has been subject to a first gesture.

3. The computer system of claim 1 wherein the instructions further configure the processor to, in response to receiving the gesture data, determine that the second device has been subject to the gesture by:
providing, to a machine learning model, the gesture data; and
receiving, from the machine learning model, a gesture indicator, the gesture indicator indicating that the second device has been subject to the gesture.

4. The computer system of claim 1 wherein the instructions further configure the processor to, prior to initiating the computing operation:
determine a first time associated with the receiving of the search request;
determine a second time associated with the gesture; and
determine that the first time and the second time are within a time threshold.

5. The computer system of claim 1 wherein initiating the computing operation further comprises:
sending, in response to determining that the first device and the second device are in the shared area, and via the communications module, a selection signal to the first device, the selection signal causing the first device to display a selectable user interface element associated with the second device; and
receiving, from the first device and via the communications module, a target selection signal indicating selection of the selectable user interface element by the first device.

6. The computer system of claim 5 wherein the instructions further configure the processor to:
prior to sending the selection signal:
receive, from a third device and via the communications module, third gesture data, the third gesture data indicating that the third device has been subject to a third gesture;
determine that the second device is an expected target relative to the third device; and
configure, based on the second device being the expected target relative to the third device, the selection signal to cause the first device to display a user interface, the user interface:
including the selectable user interface element; and
indicating, in response to determining that the second device is the expected target relative to the third device, that the second device is the expected target relative to the third device.

7. The computer system of claim 6 wherein the instructions further configure the processor to:
obtain, prior to determining that the second device is the expected target relative to the third device, a third location indicator associated with the third device; and
determine that the second device is the expected target relative to the third device by determining, based on the first location indicator, the second location indicator, and the third location indicator, that the first device is spatially closer to the second device than to the third device.

8. The computer system of claim 6 wherein the instructions further configure the processor to determine that the second device is the expected target by:
providing, to a machine learning model, first data associated with the first device, second data associated with the second device, and third data associated with the third device; and
receiving, from the machine learning model, a preference indicator, the preference indicator indicating that the second device is the expected target relative to the third device.

9. The computer system of claim 8 wherein the first data includes a computing operation history associated with the first device.

10. The computer system of claim 6 wherein the instructions further configure the processor to, prior to sending the selection signal:
determine a first time associated with the receiving of the search request;
determine a second time associated with the gesture;
determine a third time associated with the third gesture; and
determine, based on the first time, the second time, and the third time, that the second device is the expected target relative to the third device.

11. The computer system of claim 6 wherein the instructions further configure the processor to, prior to configuring the selection signal:
obtain, a third location indicator associated with the third device; and
determine, based on the first location indicator and the third location indicator that the first device and the second device are in the shared area; and
prior to sending the selection signal:
configure the user interface to include, in response to determining that the first device and the third device are in the shared area, an additional selectable user interface element associated with the third device; and
configure the user interface to indicate that the second device is the expected target relative to the third device by biassing selection of the selectable user interface element over the additional selectable user interface element.

12. The computer system of claim 11 wherein the user interface biases selection of the selectable user interface element over the additional selectable user interface element by enlarging the selectable user interface element relative to the additional selectable user interface element.

13. The computer system of claim 1 wherein the instructions further configure the processor to, prior to receiving the gesture data:
receive, from the second device and via the communications module, an application state indicator, the application state indicator indicating a state of an application launched by the second device;
determine, based on the application state indicator, that the application is in a search state; and
send, in response to determining that the application is in the search state, to the second device and via the communications module, a monitoring signal, the monitoring signal causing:
a sensor of the second device to monitor motion of the second device; and
the second device to send the gesture data to the computer system.

14. The computer system of claim 13 wherein the instructions further configure the processor to, prior to sending the monitoring signal:
receive authentication credentials from the second device; and
verify that the authentication credentials correspond to an account associated with the second device.

15. The computer system of claim 13 wherein the instructions further configure the processor to send a selection signal to the second device, the selection signal causing the second device to:
determine that the application is a foreground process; and
interrupt, in response to determining that the application is the foreground process, device operation to display a user interface including a selectable user interface element associated with the first device.

16. A computer-implemented method, the method comprising:
receiving, from a first device and via a communications module, a search request;
obtaining a first location indicator associated with the first device;
receiving, from a second device and via the communications module, gesture data, the gesture data indicating that the second device has been subject to a gesture;
obtaining a second location indicator associated with the second device;
determining, in response to receiving the gesture data, based on the first location indicator and the second location indicator, that the first device and the second device are in a shared area; and
initiating, in response to determining that the first device and the second device are in the shared area, a computing operation involving the first device and the second device.

17. The computer-implemented method of claim 16 wherein initiating the computing operation further comprises:
sending, in response to determining that the first device and the second device are in the shared area, and via the communications module, a selection signal to the first device, the selection signal causing the first device to display a selectable user interface element associated with the second device; and
receiving, from the first device and via the communications module, a target selection signal indicating selection of the selectable user interface element by the first device.

18. The computer-implemented method of claim 17 wherein the method further comprises, prior to sending the selection signal:
receiving, from a third device and via the communications module, third gesture data, the third gesture data indicating that the third device has been subject to a third gesture;
determining that the second device is an expected target relative to the third device; and
configuring, based on the second device being the expected target relative to the third device, the selection signal to cause the first device to display a user interface, the user interface:
including the selectable user interface element; and
indicating that the second device is the expected target relative to the third device.

19. The computer-implemented method of claim 16 wherein the method further comprises, prior to receiving the gesture data:
receiving, from the second device and via the communications module, an application state indicator, the application state indicator indicating a state of an application launched by the second device;
determining, based on the application state indicator, that the application is in a search state; and
sending, in response to determining that the application is in the search state, to the second device and via the communications module, a monitoring signal, the monitoring signal causing:
a sensor of the second device to monitor motion of the second device; and
the second device to send the gesture data to a computer system.

20. A non-transitory computer-readable medium storing processor-executable instructions that, when executed by a processor, cause the processor to:
receive, from a first device and via a communications module, a search request;
obtain a first location indicator associated with the first device;
receive, from a second device and via the communications module, gesture data, the gesture data indicating that the second device has been subject to a gesture;
obtain a second location indicator associated with the second device;
determine, in response to receiving the gesture data, based on the first location indicator and the second location indicator, that the first device and the second device are in a shared area; and
initiate, in response to determining that the first device and the second device are in the shared area, a computing operation involving the first device and the second device.
